(19) United States
(12) Patent Application Publication
(10) Pub. No.: US 2018/0012218 A1
(43) Pub. Date: Jan. 11, 2018

(54) Payment Method, Payer Terminal, and Payee Terminal

(71) Applicant: Huawei Technologies Co., Ltd., Shenzhen (CN)

(72) Inventors: Xiaona Zhao, Beijing (CN); Xinmiao Chang, Beijing (CN)

(21) Appl. No.: 15/538,320

(22) PCT Filed: Feb. 6, 2015
(86) PCT No.: PCT/CN2015/072409

§ 371 Date: Jun. 21, 2017

(51) Int. Cl. G06Q 20/32; G06Q 20/40; G06Q 20/22; G07F 7/08; G06Q 20/04

(52) U.S. Cl. CPC G06Q 20/3278; G07F 7/084; G06Q 20/04; G06Q 20/227; G06Q 20/405

(57) ABSTRACT

A payment method, a payer terminal, and a payee terminal are provided. The method includes receiving a transaction request from a payee terminal that includes a payment amount and determining whether an electronic cash application has a balance that is sufficient to cover the payment amount. If the balance is not sufficient, determining whether there are at least two electronic cash applications, a sum of whose balances are greater than or equal to the payment amount. If the balances are sufficient, selecting a group of electronic cash applications, a sum of whose balances are greater than or equal to the payment amount, performing deduction from a balance of each selected electronic cash application until a sum of the deduction is equal to the payment amount; and sending account number and corresponding deduction data of each of the selected electronic cash applications and transaction identifications to the payee terminal.

### CROSS-REFERENCE TO RELATED APPLICATIONS

This application is a national stage application of International Patent Application No. PCT/CN2015/072409, filed on Feb. 6, 2015, which is herein incorporated by reference in its entirety.

### TECHNICAL FIELD

Embodiments of the disclosure relate to the field of communications technologies, and in particular, to a payment method, a payer terminal, and a payee terminal.

### BACKGROUND

Currently, when electronic cash in a mobile wallet is used for offline purchase, a default card (such as a bank card, which has an electronic cash function) is usually set. During offline purchase, a user can directly perform a payment by using electronic cash of the default card, without needing to unlock a mobile phone and enter a password. When a balance of the electronic cash of the default card is insufficient, the following methods are usually used for processing.

1. If an automatic recharging threshold is set for the default card in advance, offline purchase can be conducted only after the mobile wallet is automatically recharged with the default card, which results in that a transaction time is relatively prolonged, and payment efficiency is relatively reduced.

2. If automatically switching to an online payment manner is set for the default card in advance, according to different policies of different banks, the online manner is used to deduct a remaining part of a payable amount from a primary account of the default card after an entire balance is deducted from the electronic cash, or the online manner is directly used to deduct a current payable amount from a primary account of the default card. However, online purchase requires a user to enter a password and requires a Point of Sale (POS) machine to be online, and not all merchants meet a requirement of an online payment scenario.

3. If a user chooses to use electronic cash of a non-default card to perform a payment, the user needs to unlock a mobile phone, open a wallet client, and manually select a card with a sufficient electronic cash balance. As a result, a process is relatively complex, and user experience is poor.

As a quantity of card applications downloaded and installed in a mobile wallet increases, a user usually has multiple electronic cash accounts. It can be seen from the foregoing descriptions that, multiple electronic cash accounts of a user are not fully utilized in all the solutions in the prior art, which easily causes low utilization of electronic cash in an electronic cash account, and easily causes waste of multiple electronic cash balances.

### SUMMARY

In view of this, embodiments of the disclosure provide a payment method, a payer terminal, and a payee terminal, so as to improve utilization of each electronic cash application, avoid waste of balances of multiple electronic cash applications, and significantly improve user experience.

According to a first aspect, an embodiment of the disclosure provides a payment method, where the payment method is applied to a payer terminal, and the payment method includes receiving a transaction request sent by a payee terminal, where the transaction request includes a payment amount; determining whether there is at least one electronic cash application, whose balance is sufficient to cover the payment amount, in electronic cash applications preconfigured on the payer terminal; if none of the electronic cash applications has a sufficient balance to independently cover the payment amount, determining whether there are at least two electronic cash applications, a sum of whose balances is greater than or greater than or equal to the payment amount, in the electronic cash applications; if yes, selecting a group of electronic cash applications, a sum of whose balances is greater than or greater than or equal to the payment amount, from the electronic cash applications, allocating a corresponding payment sub-amount to each selected electronic cash application, and then deducting the corresponding payment sub-amount from a balance of each selected electronic cash application, until a sum of the deduction is equal to the payment amount; associating an account number and deduction data that correspond to each selected electronic cash application with a current transaction sequence number; and sending a first payment response to the payee terminal, where the first payment response includes the current transaction sequence number, and the account number and the deduction data that correspond to each selected electronic cash application and that are associated with the current transaction sequence number; or sending a second payment response to the payee terminal, where the second payment response includes the current transaction sequence number, and sending, to a server, the current transaction sequence number, and the account number and the deduction data that correspond to each selected electronic cash application and that are associated with the current transaction sequence number, where the first payment response or the second payment response is used to instruct the payee terminal to generate, according to information included in the first payment response or in the second payment response, a settlement packet used to instruct the server to centrally perform synchronous fee deduction on accounts corresponding to the selected electronic cash applications.

With reference to the first aspect, in a first implementation manner of the first aspect, after the sending, to a server, the current transaction sequence number, and the account number and the deduction data that correspond to each selected electronic cash application and that are associated with the current transaction sequence number, the method further includes receiving a response returned by the server, where the response is used to indicate a result of synchronous fee deduction that is performed on a corresponding account of an electronic cash application by the server according to the current transaction sequence number, and the associated account number and the associated deduction data that correspond to each electronic cash application.

With reference to the first aspect, in a second implementation manner of the first aspect, the selecting a group of electronic cash applications, a sum of whose balances is greater than or greater than or equal to the payment amount, from the electronic cash applications includes selecting a group of electronic cash applications from the electronic cash applications according to any one or a combination of any multiple of priorities of the electronic cash applications, a maximum usage quantity of electronic cash applications in one transaction, or a user indication, where the group of electronic cash applications include at least two electronic cash applications, a sum of whose balances is greater than or greater than or equal to the payment amount.

With reference to the first aspect, or the first implementation manner of the first aspect, or the second implementation manner of the first aspect, in a third implementation manner of the first aspect, the allocating a corresponding payment sub-amount to each selected electronic cash application includes generating a transaction processing command for each selected electronic cash application, where each transaction processing command includes a payment sub-amount allocated to a corresponding electronic cash application by the payer terminal, and the payment sub-amount is less than or less than or equal to a balance of the corresponding electronic cash application; sending the corresponding transaction processing command to each selected electronic cash application; and receiving a transaction processing response returned by each selected electronic cash application, where each transaction processing response is used to indicate that the corresponding electronic cash application can pay the payment sub-amount.

With reference to the third implementation manner of the first aspect, in a fourth implementation manner of the first aspect, the deducting the corresponding payment sub-amount from a balance of each selected electronic cash application, until a sum of the deduction is equal to the payment amount includes generating a settlement command for each selected electronic cash application, where each settlement command is used to request a corresponding electronic cash application to deduct a corresponding payment sub-amount from a respective balance; sending the corresponding settlement command to each selected electronic cash application; and receiving a settlement response returned by each selected electronic cash application, where each settlement response includes deduction data of a corresponding electronic cash application.

With reference to the fourth implementation manner of the first aspect, in a fifth implementation manner of the first aspect, before the generating a settlement command for each selected electronic cash application, or after the receiving a settlement response returned by each selected electronic cash application, the method further includes returning a transaction response to the payee terminal, where the transaction response is used to indicate that the payer terminal can pay the payment amount, and/or used to indicate that the payer terminal can deduct the corresponding payment sub-amount from the balance of each selected electronic cash application; and receiving a payment request sent by the payee terminal.

With reference to the first aspect, or the first or the second implementation manner of the first aspect, in a sixth implementation manner of the first aspect, the allocating a corresponding payment sub-amount to each selected electronic cash application, and then deducting the corresponding payment sub-amount from a balance of each selected electronic cash application, until a sum of the deduction is equal to the payment amount includes generating a transaction processing command for each selected electronic cash application, where each transaction processing command includes a payment sub-amount allocated to a corresponding electronic cash application by the payer terminal, and the payment sub-amount is less than or less than or equal to a balance of the corresponding electronic cash application; sending the corresponding transaction processing command to each selected electronic cash application; and receiving a transaction processing response returned by each selected electronic cash application, where each transaction processing response is used to carry deduction data of a corresponding electronic cash application.

With reference to the first aspect, in a seventh implementation manner of the first aspect, the determining whether there is at least one electronic cash application, whose balance is sufficient to cover the payment amount, in electronic cash applications preconfigured on the payer terminal further includes if there is at least one electronic cash application, whose balance is sufficient to independently cover the payment amount, in the electronic cash applications, selecting one of the at least one electronic cash application to complete a current payment.

With reference to the seventh implementation manner of the first aspect, in an eighth implementation manner of the first aspect, the selecting one of the at least one electronic cash application includes selecting, according to priorities of the electronic cash applications and/or a user indication, one electronic cash application from the at least one electronic cash application whose balance is sufficient to independently cover the payment amount.

According to a second aspect, an embodiment of the disclosure provides a payment method, where the payment method is applied to a payee terminal, and the method includes sending a transaction request to a payer terminal, where the transaction request includes a payment amount; receiving a payment response sent by the payer terminal, where the payment response includes the current transaction sequence number; or the payment response includes the current transaction sequence number, and an account number and deduction data that correspond to each selected electronic cash application and that are associated with the current transaction sequence number; and encapsulating, in a settlement packet, information included in the payment response or the payment amount and information included in the payment response, and sending the settlement packet to a server, where the settlement packet is used to instruct the server to centrally perform synchronous fee deduction on accounts corresponding to the selected electronic cash.

With reference to the second aspect, in a first implementation manner of the second aspect, before the receiving a payment response sent by the payer terminal, the method further includes receiving a transaction response sent by the payer terminal, where the transaction response is used to indicate that the payer terminal can deduct a corresponding payment sub-amount from a balance of each selected electronic cash application; and sending a payment request to the payer terminal, where the payment request is used to request the payer terminal to use each selected electronic cash application to complete a current transaction.

With reference to the second aspect, in a second implementation manner of the second aspect, after the receiving a payment response sent by the payer terminal, the method further includes associating the payment amount with the information included in the payment response and storing the payment amount, the information included in the payment response, and an association relationship between the payment amount and the information included in the payment response.

With reference to the second aspect, or the first or the second implementation manner of the second aspect, in a third implementation manner of the second aspect, after the sending the settlement packet to a server, the method further includes receiving a settlement response sent by the server, where the settlement response is used to indicate that the server has centrally performed synchronous fee deduction on the accounts corresponding to the electronic cash applications associated with the current transaction sequence number.

According to a third aspect, an embodiment of the disclosure provides a payer terminal, including a first receiving unit configured to receive a transaction request sent by a payee terminal, where the transaction request includes a payment amount; a determining unit configured to determine whether there is at least one electronic cash application, whose balance is sufficient to cover the payment amount, in electronic cash applications preconfigured on the payer terminal, where the determining unit is further configured to, if none of the electronic cash applications has a sufficient balance to independently cover the payment amount, determine whether there are at least two electronic cash applications, a sum of whose balances is greater than or greater than or equal to the payment amount, in the electronic cash applications; a selection unit configured to, when there are at least two electronic cash applications, a sum of whose balances is greater than or greater than or equal to the payment amount, in the electronic cash applications, select a group of electronic cash applications, a sum of whose balances is greater than or greater than or equal to the payment amount, from the electronic cash applications; a processing unit configured to, allocate a corresponding payment sub-amount to each selected electronic cash application, then deduct the corresponding payment sub-amount from a balance of each selected electronic cash application, until a sum of the deduction is equal to the payment amount, and associate an account number and deduction data that correspond to each selected electronic cash application with a current transaction sequence number; and a first sending unit configured to send a first payment response to the payee terminal, where the first payment response includes the current transaction sequence number, and the account number and the deduction data that correspond to each selected electronic cash application and that are associated with the current transaction sequence number; or the first sending unit configured to send a second payment response to the payee terminal, where the second payment response includes the current transaction sequence number; and a second sending unit configured to send, to a server, the current transaction sequence number, and the account number and the deduction data that correspond to each selected electronic cash application and that are associated with the current transaction sequence number, where the first payment response or the second payment response is used to instruct the payee terminal to generate, according to information included in the first payment response or in the second payment response, a settlement packet used to instruct the server to centrally perform synchronous fee deduction on accounts corresponding to the selected electronic cash applications.

With reference to the third aspect, in a first implementation manner of the third aspect, the payer terminal further includes a second receiving unit configured to, after the second sending unit sends, to the server, the current transaction sequence number, and the account number and the deduction data that correspond to each selected electronic cash application and that are associated with the current transaction sequence number, receive a response returned by the server, where the response is used to indicate a result of synchronous fee deduction that is performed on a corresponding account of an electronic cash application by the server according to the current transaction sequence number, and the associated account number and the associated deduction data that correspond to each electronic cash application.

With reference to the third aspect, in a second implementation manner of the third aspect, the selecting, by the selection unit, a group of electronic cash applications, a sum of whose balances is greater than or greater than or equal to the payment amount, from the electronic cash applications includes selecting, by the selection unit, a group of electronic cash applications from the electronic cash applications according to any one or a combination of any multiple of priorities of the electronic cash applications, a maximum usage quantity of electronic cash applications in one transaction, or a user indication, where the group of electronic cash applications include at least two electronic cash applications, a sum of whose balances is greater than or greater than or equal to the payment amount.

With reference to the third aspect, or the first implementation manner of the third aspect, or the second implementation manner of the third aspect, in a third implementation manner of the third aspect, the allocating, by the processing unit, a corresponding payment sub-amount to each selected electronic cash application includes generating, by the processing unit, a transaction processing command for each selected electronic cash application, where each transaction processing command includes a payment sub-amount allocated to a corresponding electronic cash application by the payer terminal, and the payment sub-amount is less than or less than or equal to a balance of the corresponding electronic cash application; sending, by the processing unit, the corresponding transaction processing command to each selected electronic cash application; and receiving, by the processing unit, a transaction processing response returned by each selected electronic cash application, where each transaction processing response is used to indicate that the corresponding electronic cash application can pay the payment sub-amount.

With reference to the third implementation manner of the third aspect, in a fourth implementation manner of the third aspect, the deducting, by the processing unit, the corresponding payment sub-amount from a balance of each selected electronic cash application, until a sum of the deduction is equal to the payment amount includes generating, by the processing unit, a settlement command for each selected electronic cash application, where each settlement command is used to request a corresponding electronic cash application to deduct a corresponding payment sub-amount from a respective balance; sending, by the processing unit, the corresponding settlement command to each selected electronic cash application; and receiving, by the processing unit, a settlement response returned by each selected electronic cash application, where each settlement response includes deduction data of a corresponding electronic cash application.

With reference to the fourth implementation manner of the third aspect, in a fifth implementation manner of the third aspect, the first sending unit is further configured to, before the processing unit generates the settlement command for each selected electronic cash application, or after the processing unit receives the settlement response returned by each selected electronic cash application, return a transaction response to the payee terminal, where the transaction response is used to indicate that the payer terminal can pay the payment amount, and/or used to indicate that the payer terminal can deduct the corresponding payment sub-amount from the balance of each selected electronic cash application; and the first receiving unit is further configured to receive a payment request sent by the payee terminal.

With reference to the third aspect, or the first or the second implementation manner of the third aspect, in a sixth implementation manner of the third aspect, the allocating, by the processing unit, a corresponding payment sub-amount to each selected electronic cash application, and then deducting the corresponding payment sub-amount from a balance of each selected electronic cash application, until a sum of the deduction is equal to the payment amount includes generating, by the processing unit, a transaction processing command for each selected electronic cash application, where each transaction processing command includes a payment sub-amount allocated to a corresponding electronic cash application by the payer terminal, and the payment sub-amount is less than or less than or equal to a balance of the corresponding electronic cash application; sending, by the processing unit, the corresponding transaction processing command to each selected electronic cash application; and receiving, by the processing unit, a transaction processing response returned by each selected electronic cash application, where each transaction processing response is used to carry deduction data of a corresponding electronic cash application.

With reference to the third aspect, in a seventh implementation manner of the third aspect, the selection unit is further configured to, when a result of the determining by the determining unit is that there is at least one electronic cash application, whose balance is sufficient to cover the payment amount, in the electronic cash applications preconfigured on the payer terminal, select one of the at least one electronic cash application to complete a current payment.

With reference to the seventh implementation manner of the third aspect, in an eighth implementation manner of the third aspect, the selecting, by the selection unit, one of the at least one electronic cash application includes selecting, by the selection unit according to priorities of the electronic cash applications and/or a user indication, one electronic cash application from the at least one electronic cash application whose balance is sufficient to independently cover the payment amount.

According to a fourth aspect, an embodiment of the disclosure provides a payee terminal, including a first sending unit configured to send a transaction request to a payer terminal, where the transaction request includes a payment amount; a first receiving unit configured to receive a payment response sent by the payer terminal, where the payment response includes the current transaction sequence number; or the payment response includes the current transaction sequence number, and an account number and deduction data that correspond to each selected electronic cash application and that are associated with the current transaction sequence number; a processing unit configured to encapsulate, in a settlement packet, information included in the payment response or the payment amount and information included in the payment response; and a second sending unit configured to send the settlement packet to a server, where the settlement packet is used to instruct the server to centrally perform synchronous fee deduction on accounts corresponding to the selected electronic cash.

With reference to the fourth aspect, in a first implementation manner of the fourth aspect, the first receiving unit is further configured to, before receiving the payment response sent by the payer terminal, receive a transaction response sent by the payer terminal, where the transaction response is used to indicate that the payer terminal can deduct a corresponding payment sub-amount from a balance of each selected electronic cash application; and the first sending unit is further configured to send a payment request to the payer terminal, where the payment request is used to request the payer terminal to use each selected electronic cash application to complete a current transaction.

With reference to the fourth aspect, in a second implementation manner of the fourth aspect, the payee terminal further includes a storage unit configured to, after the first receiving unit receives the payment response sent by the payer terminal, associate the payment amount with the information included in the payment response and store the payment amount, the information included in the payment response, and an association relationship between the payment amount and the information included in the payment response.

With reference to the fourth aspect, or the first or the second implementation manner of the fourth aspect, in a third implementation manner of the fourth aspect, the payee terminal further includes a second receiving unit configured to, after the second sending unit sends the settlement packet to the server, receive a settlement response sent by the server, where the settlement response is used to indicate that the server has centrally performed synchronous fee deduction on the accounts corresponding to the electronic cash applications associated with the current transaction sequence number.

According to a fifth aspect, an embodiment of the disclosure provides a payer terminal, including a first transceiver configured to receive a transaction request sent by a payee terminal, where the transaction request includes a payment amount; and a processor configured to, determine whether there is at least one electronic cash application, whose balance is sufficient to cover the payment amount, in electronic cash applications preconfigured on the payer terminal; and if none of the electronic cash applications has a sufficient balance to independently cover the payment amount, determine whether there are at least two electronic cash applications, a sum of whose balances is greater than or greater than or equal to the payment amount, in the electronic cash applications, where the processor is further configured to, when there are at least two electronic cash applications, a sum of whose balances is greater than or greater than or equal to the payment amount, in the electronic cash applications, select a group of electronic cash applications, a sum of whose balances is greater than or greater than or equal to the payment amount, from the electronic cash applications; the processor is further configured to allocate a corresponding payment sub-amount to each selected electronic cash application, then deduct the corresponding payment sub-amount from a balance of each selected electronic cash application until a sum of the deduction is equal to the payment amount, and associate an account number and deduction data that correspond to each selected electronic cash application with a current transaction sequence number; and the first transceiver is further configured to send a first payment response to the payee terminal, where the first payment response includes the current transaction sequence number, and the account number and the deduction data that correspond to each selected electronic cash application and that are associated with the current transaction sequence number; or the first transceiver is further configured to send a second payment response to the payee terminal, where the second payment response includes the current transaction sequence number; and a second transceiver configured to send, to a server, the current transaction sequence number, and the account number and the deduction data that correspond to each selected electronic cash application and that are associated with the current transaction sequence number, where the first payment response or the second payment response is used to instruct the payee terminal to generate, according to information included in the first payment response or in the second payment response, a settlement packet used to instruct the server to centrally perform synchronous fee deduction on accounts corresponding to the selected electronic cash applications.

With reference to the fifth aspect, in a first implementation manner of the fifth aspect, the second transceiver is further configured to after sending, to the server, the current transaction sequence number, and the account number and the deduction data that correspond to each selected electronic cash application and that are associated with the current transaction sequence number, receive a response returned by the server, where the response is used to indicate a result of synchronous fee deduction that is performed on a corresponding account of an electronic cash application by the server according to the current transaction sequence number, and the associated account number and the associated deduction data that correspond to each electronic cash application.

With reference to the fifth aspect, in a second implementation manner of the fifth aspect, the selecting, by the processor, a group of electronic cash applications, a sum of whose balances is greater than or greater than or equal to the payment amount, from the electronic cash applications includes selecting, by the processor, a group of electronic cash applications from the electronic cash applications according to any one or a combination of any multiple of priorities of the electronic cash applications, a maximum usage quantity of electronic cash applications in one transaction, or a user indication, where the group of electronic cash applications include at least two electronic cash applications, a sum of whose balances is greater than or greater than or equal to the payment amount.

With reference to the fifth aspect, or the first implementation manner of the fifth aspect, or the second implementation manner of the fifth aspect, in a third implementation manner of the fifth aspect, the allocating, by the processor, a corresponding payment sub-amount to each selected electronic cash application includes generating, by the processor, a transaction processing command for each selected electronic cash application, where each transaction processing command includes a payment sub-amount allocated to a corresponding electronic cash application by the payer terminal, and the payment sub-amount is less than or less than or equal to a balance of the corresponding electronic cash application; sending, by the processor, the corresponding transaction processing command to each selected electronic cash application; and receiving, by the processor, a transaction processing response returned by each selected electronic cash application, where each transaction processing response is used to indicate that the corresponding electronic cash application can pay the payment sub-amount.

With reference to the third implementation manner of the fifth aspect, in a fourth implementation manner of the fifth aspect, the deducting, by the processor, the corresponding payment sub-amount from a balance of each selected electronic cash application, until a sum of the deduction is equal to the payment amount includes generating, by the processor, a settlement command for each selected electronic cash application, where each settlement command is used to request a corresponding electronic cash application to deduct a corresponding payment sub-amount from a respective balance; sending, by the processor, the corresponding settlement command to each selected electronic cash application; and receiving, by the processor, a settlement response returned by each selected electronic cash application, where each settlement response includes deduction data of a corresponding electronic cash application.

With reference to the fourth implementation manner of the fifth aspect, in a fifth implementation manner of the fifth aspect, the first transceiver is further configured to, before the processor generates the settlement command for each selected electronic cash application, or after the processor receives the settlement response returned by each selected electronic cash application, return a transaction response to the payee terminal, where the transaction response is used to indicate that the payer terminal can pay the payment amount; and the first transceiver is further configured to receive a payment request sent by the payee terminal.

With reference to the fifth aspect, or the first or the second implementation manner of the fifth aspect, in a sixth implementation manner of the fifth aspect, the allocating, by the processing unit, a corresponding payment sub-amount to each selected electronic cash application, and then deducting the corresponding payment sub-amount from a balance of each selected electronic cash application, until a sum of the deduction is equal to the payment amount includes generating, by the processor, a transaction processing command for each selected electronic cash application, where each transaction processing command includes a payment sub-amount allocated to a corresponding electronic cash application by the payer terminal, and the payment sub-amount is less than or less than or equal to a balance of the corresponding electronic cash application; sending, by the processor, the corresponding transaction processing command to each selected electronic cash application; and receiving, by the processor, a transaction processing response returned by each selected electronic cash application, where each transaction processing response is used to carry deduction data of a corresponding electronic cash application.

With reference to the fifth aspect, in a seventh implementation manner of the fifth aspect, the processor is further configured to, when a result of the determining is that there is at least one electronic cash application, whose balance is sufficient to cover the payment amount, in the electronic cash applications preconfigured on the payer terminal, select one of the at least one electronic cash application to complete a current payment.

With reference to the seventh implementation manner of the fifth aspect, in an eighth implementation manner of the fifth aspect, the selecting, by the processor, one of the at least one electronic cash application includes selecting, by the processor according to priorities of the electronic cash applications and/or a user indication, one electronic cash application from the at least one electronic cash application whose balance is sufficient to independently cover the payment amount.

According to a sixth aspect, an embodiment of the disclosure provides a payee terminal, including a first transceiver configured to send a transaction request to a payer terminal, where the transaction request includes a payment amount; and receive a payment response sent by the payer terminal, where the payment response includes the current transaction sequence number; or the payment response includes the current transaction sequence number, and an account number and deduction data that correspond to each selected electronic cash application and that are associated with the current transaction sequence number; a processor configured to encapsulate, in a settlement packet, information included in the payment response or the payment amount and information included in the payment response; and a second transceiver configured to send the settlement packet to a server, where the settlement packet is used to instruct the server to centrally perform synchronous fee deduction on accounts corresponding to the selected electronic cash.

With reference to the sixth aspect, in a first implementation manner of the sixth aspect, the first transceiver is further configured to, before receiving the payment response sent by the payer terminal, receive a transaction response sent by the payer terminal, where the transaction response is used to indicate that the payer terminal can deduct a corresponding payment sub-amount from a balance of each selected electronic cash application; and the first transceiver is further configured to send a payment request to the payer terminal, where the payment request is used to request the payer terminal to use each selected electronic cash application to complete a current transaction.

With reference to the sixth aspect, in a second implementation manner of the sixth aspect, the payee terminal further includes a memory configured to, after the first transceiver receives the payment response sent by the payer terminal, associate the payment amount with the information included in the payment response and store the payment amount, the information included in the payment response, and an association relationship between the payment amount and the information included in the payment response.

With reference to the sixth aspect, or the first or the second implementation manner of the sixth aspect, in a third implementation manner of the sixth aspect, the second transceiver is further configured to, after sending the settlement packet to the server, receive a settlement response sent by the server, where the settlement response is used to indicate that the server has centrally performed synchronous fee deduction on the accounts corresponding to the electronic cash applications associated with the current transaction sequence number.

It can be seen from the foregoing technical solutions that the embodiments of the disclosure have the following advantages.

In the embodiments of the disclosure, after receiving a transaction request that is sent by a payee terminal and that includes a payment amount, a payer terminal first determines whether there is at least one electronic cash application, whose balance is sufficient to cover the payment amount, in electronic cash applications preconfigured on the payer terminal; if none of the electronic cash applications has a sufficient balance to independently cover the payment amount, the payer terminal determines whether there are at least two electronic cash applications, a sum of whose balances is greater than or greater than or equal to the payment amount, in the electronic cash applications; if yes, the payer terminal selects a group of electronic cash applications, a sum of whose balances is greater than or greater than or equal to the payment amount, to complete a payment, associates an account number and deduction data that correspond to each selected electronic cash application with a transaction sequence number, and then sends a payment response to the payee terminal. That is, in the embodiments of the disclosure, a default electronic cash application is not necessarily preferentially used to perform a payment, but determining is performed according to a balance of each electronic cash application and a payment amount. When there is at least one electronic cash application whose balance is sufficient to independently complete the payment, a most proper electronic cash application may be selected according to a situation to implement the payment. When none of the electronic cash applications has a sufficient balance to independently complete the payment, multiple electronic cash applications, a sum of whose balances meets the payment amount, on a payer terminal are selected to complete the payment. An account number and deduction data that correspond to each selected electronic cash application are associated with a transaction sequence number. Then a payment response needs to be sent to a payee terminal for only once. Therefore, utilization of each electronic cash application can be improved, waste of balances of multiple electronic cash applications can be avoided, and user experience can be significantly improved.

### BRIEF DESCRIPTION OF DRAWINGS

To describe the technical solutions in the embodiments of the disclosure more clearly, the following briefly describes the accompanying drawings required for describing the embodiments of the disclosure. Apparently, the accompanying drawings in the following description show merely some embodiments, and a person skilled in the art may still derive other drawings from these accompanying drawings.

FIG. 1 is a schematic diagram of an embodiment of a payment method according to the disclosure;

FIG. 2 is a schematic diagram of another embodiment of a payment method according to the disclosure;

FIG. 3 is a schematic diagram of another embodiment of a payment method according to the disclosure;

FIG. 4 is a schematic diagram of an embodiment of a payer terminal according to the disclosure;

FIG. 5 is a schematic diagram of another embodiment of a payer terminal according to the disclosure;

FIG. 6 is a schematic diagram of another embodiment of a payer terminal according to the disclosure;

FIG. 7 is a schematic diagram of an embodiment of a payee terminal according to the disclosure; and

FIG. 8 is a schematic diagram of another embodiment of a payee terminal according to the disclosure.

### DESCRIPTION OF EMBODIMENTS

The following clearly and completely describes the technical solutions in the embodiments of the disclosure with reference to the accompanying drawings in the embodiments of the disclosure. Apparently, the described embodiments are merely some but not all of the embodiments of the disclosure. All other embodiments obtained by a person skilled in the art based on the embodiments of the disclosure shall fall within the protection scope of the disclosure.

The embodiments of the disclosure provide a payment method, a payer terminal, and a payee terminal. The payer terminal may include, but is not limited to, a terminal device such as a mobile phone, a tablet computer, or a personal digital assistant (PDA). The payer terminal includes multiple electronic cash applications. An electronic cash application may be an electronic cash function (that is, a micropayment function based on a debit/credit application, for example, a micropayment function formulated by The People's Bank of China (PBOC), that provides a solution to an offline transaction using a debit/credit card) of a financial integrated circuit (IC) card, or may be an independent application specially used for micropayment in an offline state, and coexist in a same card with a debit/credit application. Correspondingly, in the embodiments of the disclosure, an electronic cash application may be a micropayment function of a debit/credit application on the payer terminal, or may be an independent application used for micropayment in an offline state, so that in an offline transaction, micropayment by card can be performed without needing to enter a password. According to the embodiments of the disclosure, utilization of each electronic cash application can be improved, waste of balances of multiple electronic cash applications can be avoided, and user experience can be significantly improved.

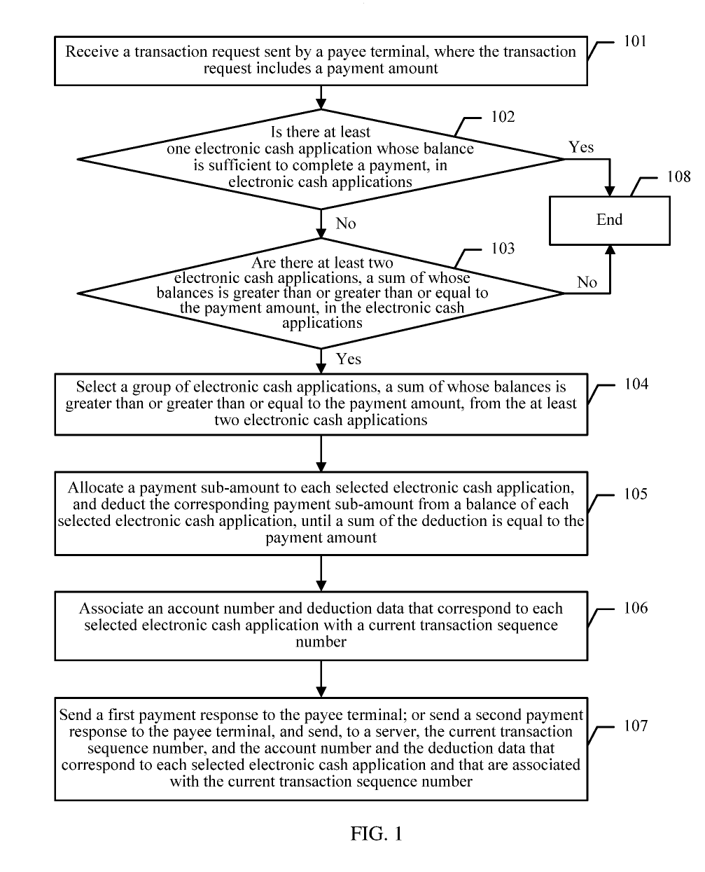

Referring to FIG. 1, an embodiment of a payment method according to the disclosure includes the following steps.

Step 101. Receive a transaction request sent by a payee terminal, where the transaction request includes a payment amount.

In a specific implementation, the payee terminal may be a POS machine, or may be another intelligent terminal having a money collection function, such as a mobile phone or a tablet computer.

Step 102. Determine whether there is at least one electronic cash application, whose balance is sufficient to cover or complete the payment amount, in electronic cash applications preconfigured on a payer terminal; and if yes, perform step 108 of ending the processing, or if not, perform step 103.

In a specific implementation, a balance of each electronic cash application may be obtained in the following manners. In a first manner, the payer terminal may maintain a list of electronic cash applications in advance. The list of electronic cash applications includes an electronic cash balance corresponding to each electronic cash application. When the payer terminal is used, the list of electronic cash applications is directly queried to obtain the balance of each electronic cash application. In a second manner, each time the payer terminal receives a transaction request sent by the payee terminal, the payer terminal obtains the balance from each electronic cash application in real time, that is, obtains the balance of each electronic cash application by sending a query command to each electronic cash application or a card application associated with each electronic cash application.

There is at least one electronic cash application whose balance is sufficient to cover the payment amount may be a balance of at least one of these electronic cash applications that is greater than or greater than or equal to the payment amount; or may be a balance of at least one of these electronic cash applications that is greater than or greater than or equal to the payment amount, and a single transaction limit (that is, a maximum amount that can be paid in a single offline transaction) of the at least one electronic cash application that is greater than or greater than or equal to the payment amount.

Correspondingly, none of the electronic cash applications has a sufficient balance to independently cover the payment amount may be a balance of any electronic cash application that is less than or less than or equal to the payment amount; or may be a balance of any electronic cash application that is greater than or greater than or equal to the payment amount, but a single transaction limit (that is, a maximum amount that can be paid in a single offline transaction) of any electronic cash application is less than or less than or equal to the payment amount.

Optionally, an implementation manner of the determining whether there is at least one electronic cash application, whose balance is sufficient to cover the payment amount, in electronic cash applications preconfigured on a payer terminal in the foregoing step 102 includes, but is not limited to, any one of the following.

(1) If the payer terminal presets an electronic cash application as a default electronic cash application, that is, an electronic cash application that is first selected to be used by the payer terminal in a transaction, the payer terminal first determines whether a balance of the default electronic cash application is sufficient to cover a payment amount required in a current transaction. If yes, the default electronic cash application is selected. If not, a non-default electronic cash application is searched, according to priorities of all electronic cash applications on the terminal and/or a user indication, for an electronic cash application that can independently complete a current payment. If no electronic cash application that can independently complete a current payment can be found, step 103 is then performed.

(2) After acquiring balances of all electronic cash applications in either of the foregoing manners of acquiring a balance of each electronic cash application, the terminal determines an electronic cash application whose balance is sufficient to cover a payment amount required in a current transaction. If there are multiple electronic cash applications whose balances are sufficient to cover the payment amount required in the current transaction, an electronic cash application whose priority is the highest in the multiple electronic cash applications may be selected according to priorities of all the electronic cash applications, or a selection is made according to a user indication, or an electronic cash application whose balance is the most in the multiple electronic cash applications is selected according to balances, or the like, and no further details are provided herein one by one. If there is only one electronic cash application whose balance is sufficient to cover the payment amount required in the current transaction, this electronic cash application is directly selected. If there is no electronic cash application whose balance is sufficient to cover the payment amount required in the current transaction, step 103 is then performed.

Step 103. Determine whether there are at least two electronic cash applications, a sum of whose balances is greater than or greater than or equal to the payment amount, in the electronic cash applications; and if yes, perform step 104, or if not, perform step 108 of ending the processing.

Step 104. Select a group of electronic cash applications, a sum of whose balances is greater than or greater than or equal to the payment amount, from at least two electronic cash applications.

Step 105. Allocate a corresponding payment sub-amount to each selected electronic cash application, and deduct the corresponding payment sub-amount from a balance of each selected electronic cash application, until a sum of the deduction is equal to the payment amount.

When the payer terminal performs successive deduction from the balance of each selected electronic cash application, it needs to be ensured that a deduction amount each time does not exceed (that is, is less than or less than or equal to) a balance corresponding to each electronic cash application. Alternatively, it needs to be ensured that a deduction amount each time does not exceed a balance corresponding to each electronic cash application and a corresponding single transaction limit. Alternatively, it needs to be ensured that a deduction amount each time does not exceed a balance corresponding to each electronic cash application and a corresponding single transaction limit, and a balance after the deduction is not less than (that is, greater than or greater than or equal to) a bottom limit for credit for load/recharging (that is, a minimum balance that triggers credit for load/recharging of the balance of the electronic cash application) that corresponds to each electronic cash application.

Step 106. Associate an account number and deduction data that correspond to each selected electronic cash application with a current transaction sequence number.

The account number corresponding to each selected electronic cash application may be a primary account number (which, for example, includes a particular length of digits meeting a requirement of a corresponding bank) of a bank card associated with the electronic cash application or an identifier (where the identifier may be construed as a substitute value of the primary account number of the bank card that is sent by a card issuing bank or a third-party organization to the payer terminal, and a length of the identifier may be less than that of the primary account number) that uniquely corresponds to the primary account number; or may be an account number or an identifier that is individually allocated by a card issuing bank or a third-party organization to each electronic cash application; or may be a number that is allocated by the payer terminal to each selected electronic cash when the payer terminal associates all electronic cash applications, where an association relationship between an identifier of the payer terminal and the number of each electronic cash application that is associated by the payer terminal is also stored in a server; or certainly, may be a combination of any multiple of the three. In addition, the deduction data corresponding to each selected electronic cash application may be the payment sub-amount corresponding to the electronic cash application, or may be a balance corresponding to each electronic cash application after the deduction, or certainly, may be a combination of the two. Moreover, the current transaction sequence number is generated by the payer terminal, and is used to number the transaction operation of deducting the corresponding payment sub-amount from the balance corresponding to each selected electronic cash application, until a sum of the deduction is equal to the payment amount, so as to notify the payee terminal and/or the server that multiple electronic cash applications are used in the current transaction. The explanations or descriptions of the account number and the deduction data that correspond to each selected electronic cash application, and the current transaction sequence number herein are also applicable to same concepts below, and the details are not described below.

Step 107. Send a first payment response to the payee terminal; or send a second payment response to the payee terminal, and send, to a server, the current transaction sequence number, and the account number and the deduction data that correspond to each selected electronic cash application and that are associated with the current transaction sequence number.

The first payment response includes the current transaction sequence number, and the account number and the deduction data that correspond to each selected electronic cash application and that are associated with the current transaction sequence number. The second payment response includes the current transaction sequence number. The first payment response is used to instruct the payee terminal to generate, according to information included in the first payment response, a settlement packet used to instruct the server to centrally perform synchronous fee deduction on accounts corresponding to the selected electronic cash applications. The second payment response is used to instruct the payee terminal to generate, according to information included in the second payment response, a settlement packet used to instruct the server to centrally perform synchronous fee deduction on the accounts corresponding to the selected electronic cash applications.

It should be noted that the first payment response or the second payment response may further include at least the payment amount. If the first payment response or the second payment response does not include the payment amount, but the payee terminal needs to add the payment amount to the settlement packet, the payee terminal may automatically add the payment amount required in the current transaction to the settlement packet. The payer terminal may clearly notify, by using the single first or second payment response, the payee terminal that multiple electronic cash applications are used in the current transaction. In a case in which the payer terminal sends the second payment response to the payee terminal, the payer terminal needs to send, to the server, the current transaction sequence number, and the account number and the deduction data that correspond to each of the multiple electronic cash applications that are associated with the current transaction sequence number, in order to ensure that the server clearly learns the electronic cash applications that are used by the payer terminal in the current transaction, so that the server centrally performs synchronous fee deduction on accounts corresponding to the electronic cash applications used in the current transaction.

In this embodiment, in a used implementation method, it is first determined whether a balance of any electronic cash application is sufficient. If the balance is not sufficient, it is then determined whether a sum of balances of all electronic cash applications is sufficient. Certainly, the disclosure is not limited to the implementation method described in this embodiment. For example, it may further be first determined whether a sum of balances of all electronic cash applications is sufficient. If the sum of the balances is sufficient, it is then determined whether there is a single electronic cash application whose balance is sufficient; otherwise, a payment procedure is directly ended.

In this embodiment, after a transaction request sent by a payee terminal is received, determining is first performed on a balance of each electronic cash application. When there is at least one electronic cash application whose balance is sufficient to independently complete a payment, a most proper electronic cash application may be selected according to a situation to implement the payment. When none of the electronic cash applications has a sufficient balance to independently complete the payment, multiple electronic cash applications, a sum of whose balances meets a payment amount, on a payer terminal are selected to implement the payment. An account number and deduction data that correspond to each selected electronic cash application are associated with a transaction sequence number. Then a payment response needs to be sent to the payee terminal for only once. Therefore, utilization of each electronic cash application can be improved, waste of balances of multiple electronic cash applications can be avoided, and user experience can be significantly improved.

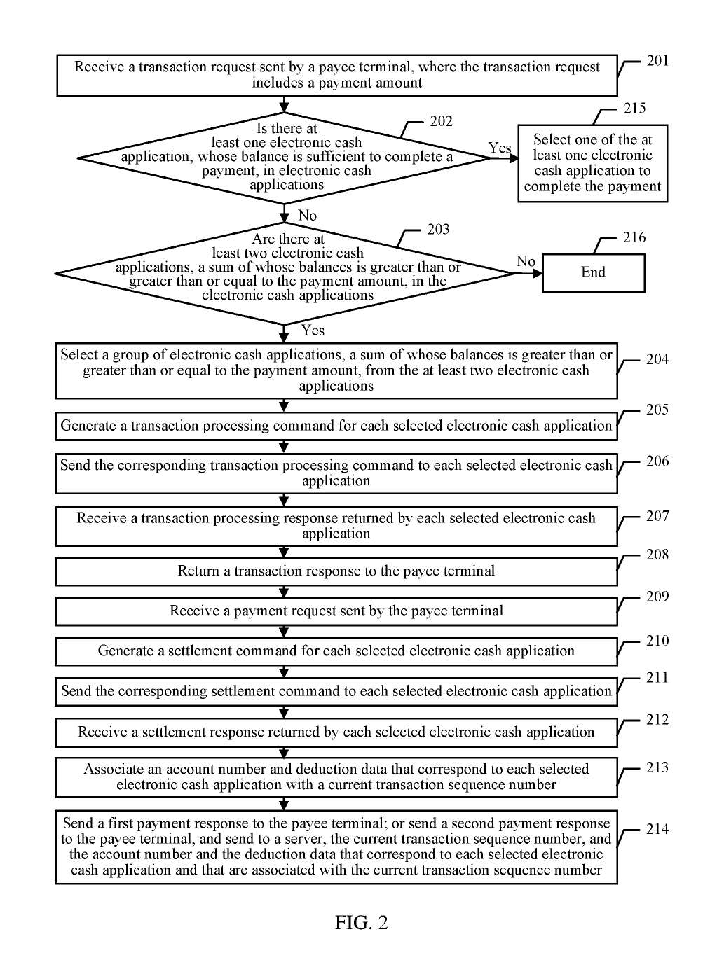

Referring to FIG. 2 below, another embodiment of a payment method according to the disclosure includes the following steps.

Step 201. Receive a transaction request sent by a payee terminal, where the transaction request includes a payment amount.

Step 202. Determine whether there is at least one electronic cash application, whose balance is sufficient to cover or complete the payment amount, in electronic cash applications preconfigured on a payer terminal; and if yes, perform step 215, or if not, perform step 203.

For a specific determining process, refer to the embodiment shown in FIG. 1, and the details are not described herein again. In this embodiment, when a result of the determining is that a balance of any electronic cash application can independently cover the payment amount, any one of electronic cash applications that are capable of independently paying the payment amount is selected to complete the payment. When none of the electronic cash applications has a sufficient balance to independently cover the payment amount, proceed to determining in step 203.

Step 203. Determine whether there are at least two electronic cash applications, a sum of whose balances is greater than or greater than or equal to the payment amount, in the electronic cash applications; and if yes, perform step 204, or if not, perform step 216 of ending the processing.

In this embodiment, when there are not at least two electronic cash applications, a sum of whose balances is greater than or greater than or equal to the payment amount, in the electronic cash applications, a current transaction is ended, that is, the transaction fails. In another embodiment, in this case, payment may be continued in another manner, for example, prompting a user to select or automatically selecting one of the electronic cash applications for credit for load, and after the credit for load is successful, completing the current payment; or selecting and deducting a first balance of one of the electronic cash applications, and deducting, in an online manner, a difference between the payment amount and the first balance from a bank card account that is associated with the electronic cash application; or deducting, in an online manner, the payment amount from the bank card account that is associated with the electronic cash application.

Step 204. Select a group of electronic cash applications, a sum of whose balances is greater than or greater than or equal to the payment amount, from the electronic cash applications.

A specific selection method may be selecting a group of electronic cash applications from the electronic cash applications according to any one or a combination of any multiple of priorities of the electronic cash applications, a maximum usage quantity of electronic cash applications in one transaction, or a user indication, where the group of electronic cash applications include at least two electronic cash applications, a sum of whose balances is greater than or greater than or equal to the payment amount.

Step 205. Generate a transaction processing command for each selected electronic cash application.

Each transaction processing command includes a payment sub-amount allocated to a corresponding electronic cash application by the payer terminal, and the payment sub-amount is less than or less than or equal to a balance of the corresponding electronic cash application.

Step 206. Send the corresponding transaction processing command to each selected electronic cash application.

Step 207. Receive a transaction processing response returned by each selected electronic cash application.

The transaction processing response is used to indicate that the corresponding electronic cash application can pay the payment sub-amount, which may be the balance of each electronic cash application is greater than or greater than or equal to the corresponding payment sub-amount; or may be the balance of each electronic cash application is greater than or greater than or equal to the corresponding payment sub-amount, and a single transaction limit of each electronic cash application is greater than or greater than or equal to the corresponding payment sub-amount.

Optionally, each transaction processing response includes location entry information of related data of the corresponding electronic cash application, so that the payer terminal obtains the related data from the corresponding electronic cash application by using the location entry information, to perform an operation, such as offline data authentication or terminal risk management, that is defined in a PBOC standard, and no further details are provided herein.

In steps 205 to 207, transaction feasibility assessment on each selected electronic cash application is implemented.

Step 208. Return a transaction response to the payee terminal.

The transaction response is used to indicate that the payer terminal can pay the payment amount, and/or used to indicate that the payer terminal can deduct the corresponding payment sub-amount from the balance of each selected electronic cash application.

The transaction response may include indication information, where the indication information may be used to indicate that the payer terminal can pay the payment amount, and/or the payer terminal needs to complete a current payment by using multiple electronic cash applications.

Step 209. Receive a payment request sent by the payee terminal.

Step 210. Generate a settlement command for each selected electronic cash application.

Each settlement command includes a payment sub-amount of each electronic cash application. Each settlement command is used to request a corresponding electronic cash application to deduct a corresponding payment sub-amount from a respective balance.

Step 211. Send the corresponding settlement command to each selected electronic cash application.

Step 212. Receive a settlement response returned by each selected electronic cash application.

Each settlement response includes deduction data of a corresponding electronic cash application.

In steps 210 to 212, the corresponding payment sub-amount is deducted from each selected electronic cash application. Optionally, before returning the transaction response to the payee terminal or sending the corresponding settlement command to each selected electronic cash application, the payer terminal may obtain corresponding related data from each selected electronic cash application according to a situation of the foregoing steps 205 to 207, for an operation, such as offline data authentication or terminal risk management, that is defined in a PBOC standard, and no further details are provided herein. Similarly, before sending the payment request, the payee terminal may obtain corresponding related data from the payer terminal, for an operation, such as offline data authentication or terminal risk management, that is defined in a PBOC standard, and no further details are provided herein.

Optionally, the foregoing steps 210 to 212 may be combined in steps 205 to 207 for execution. That is, the payer terminal sends a corresponding transaction processing command to each selected electronic cash application; after it is determined that each selected electronic cash can pay a corresponding payment sub-amount, the corresponding payment sub-amount is directly deducted from a corresponding balance; a transaction processing response is then returned to the payer terminal, where the transaction processing response may include location entry information of related data of the corresponding electronic cash application, and current deduction data; and after receiving the transaction processing response returned by each selected electronic cash application, the payer terminal may obtain corresponding related data from each selected electronic cash by using a method similar to the foregoing method, for an operation, such as offline data authentication or terminal risk management, that is defined in a PBOC standard, and no further details are provided herein.

In this case, it should be noted that, the data obtained by the payer terminal from each selected electronic cash application is different from the data obtained by the payee terminal from the payer terminal. Location entry information of related data of each electronic cash application in the former data is visible to the payer terminal, while location entry information of related data of the payer terminal in the latter data is visible to the payee terminal.

Step 213. Associate an account number and deduction data that correspond to each selected electronic cash application with a current transaction sequence number.

The corresponding account number includes one or more of an account number of the corresponding electronic cash application or an account number of a payment card associated with the corresponding electronic cash application. The corresponding deduction data includes one or more of the corresponding deducted payment sub-amount or a corresponding balance after the deduction. For specific explanations of the account number and the deduction data that correspond to each selected electronic cash application, and the current transaction sequence number, refer to corresponding descriptions in step 106 in the embodiment shown in FIG. 1, and the details are not described herein again.

Step 214. Send a first payment response to the payee terminal; or send a second payment response to the payee terminal, and send, to a server, the current transaction sequence number, and the account number and the deduction data that correspond to each selected electronic cash application and that are associated with the current transaction sequence number.

The first payment response includes the current transaction sequence number, and the account number and the deduction data that correspond to each selected electronic cash application and that are associated with the current transaction sequence number. The second payment response includes the current transaction sequence number. The first payment response is used to instruct the payee terminal to generate, according to information included in the first payment response, a settlement packet used to instruct the server to centrally perform synchronous fee deduction on accounts corresponding to the selected electronic cash applications. The second payment response is used to instruct the payee terminal to generate, according to information included in the second payment response, a settlement packet used to instruct the server to centrally perform synchronous fee deduction on the accounts corresponding to the selected electronic cash applications.

It should be noted that the first payment response or the second payment response may further include at least the payment amount. If the first payment response or the second payment response does not include the payment amount, but the payee terminal needs to add the payment amount to the settlement packet, the payee terminal may automatically add the payment amount required in the current transaction to the settlement packet. The payer terminal may clearly notify, by using the single first or second payment response, the payee terminal that multiple electronic cash applications are used in the current transaction. In a case in which the payer terminal sends the second payment response to the payee terminal, the payer terminal needs to send, to the server, the current transaction sequence number, and the account number and the deduction data that correspond to each of the multiple electronic cash applications that are associated with the current transaction sequence number, in order to ensure that the server clearly learns the electronic cash applications that are used by the payer terminal in the current transaction, so that the server centrally performs synchronous fee deduction on accounts corresponding to the electronic cash applications used in the current transaction.

Deduction data of each electronic cash application refers to data that is generated in a process in which the payer terminal performs deduction processing on each selected electronic cash application. Usually, after completing the transaction, the payee terminal collects transaction data of a period of time (for example, one day), and then sends the transaction data to the server in a form of a settlement packet. After receiving the data, the server determines whether the transaction data is electronic cash transaction data. If yes, the server performs fee deduction on the corresponding electronic cash application, to ensure that an electronic cash account amount corresponding to an electronic cash application maintained by the server is consistent with a balance of an electronic cash application that is stored in the payer terminal.

It should be noted that the payer terminal may send, to the server by using a network such as a mobile network or a wireless network, the current transaction sequence number, and the account number and the deduction data that correspond to each selected electronic cash application and that are associated with the current transaction sequence number; and the payee terminal may also send the settlement packet to the server by using a network such as a mobile network or a wireless network.

In another embodiment, the foregoing steps 208 and 209 may not be performed, or may be performed after step 212. Performing of steps 205 to 207 and steps 210 to 212 may be crossed. For example, first, the payer terminal may generate a corresponding transaction processing command for a first selected electronic cash application, and then send the transaction processing command to the electronic cash application. After receiving a transaction processing response, the payer terminal generates a settlement command for the electronic cash application, and sends the settlement command to the electronic cash application. Finally, the payer terminal receives a settlement response. Then the payer terminal performs, for a next (a second, a third, . . . ) selected electronic cash application, an operation similar to the operation that is performed for the foregoing first selected electronic cash application. Further For example, the payer terminal may generate corresponding transaction processing commands for all selected electronic cash applications at the same time, and then send the transaction processing commands to the corresponding electronic cash applications at the same time. Then the payer terminal receives, at the same time, transaction processing responses returned by all the electronic cash applications, and finally, generates corresponding settlement commands at the same time, sends the settlement commands at the same time, and receives corresponding settlement responses at the same time. Still further For example, the payer terminal may generate corresponding transaction processing commands for all selected electronic cash applications at the same time, and then sequentially send the corresponding transaction processing commands to the electronic cash applications. After sequentially receiving transaction processing responses sent by all the electronic cash applications, the payer terminal then generates corresponding settlement commands for all the selected electronic cash applications at the same time, then sequentially sends the corresponding settlement commands to the electronic cash applications, and sequentially receives settlement responses of all the electronic cash applications. Still further For example, the payer terminal may generate corresponding transaction processing commands for all selected electronic cash applications at the same time, and then send a corresponding transaction processing command to a first selected electronic cash application. After receiving a corresponding transaction processing response, the payer terminal generates a corresponding settlement command for the first selected electronic cash application, and sends the settlement command to the first electronic cash application. After receiving a corresponding settlement response, the payer terminal performs, for a next (a second, a third, . . . ) selected electronic cash application, an operation similar to the operation that is performed for the foregoing first selected electronic cash application. Still further For example, the payer terminal may generate corresponding transaction processing commands for all selected electronic cash applications at the same time, and then send a corresponding transaction processing command to a first selected electronic cash application. After receiving a corresponding transaction processing response, the payer terminal performs a similar operation for a next (a second, a third, . . . ) selected electronic cash application, until the payer terminal receives a transaction processing response that is returned by a last selected electronic cash application. Then the payer terminal generates corresponding settlement commands for all the selected electronic cash applications at the same time, and performs, for each electronic cash application, an operation specific to a transaction processing command and similar to the foregoing operation that is performed for each electronic cash application, until the payer terminal receives a settlement response that is returned by the last selected electronic cash application. All other possible execution methods that can be implemented in this way fall within the protection scope of the disclosure, and no further details are provided herein one by one.

Moreover, performing of the foregoing steps 205 to 207 and steps 210 to 212 may also be combined for execution, that is, a deduction action implemented in steps 210 to 212 may be combined in steps 205 to 207 for execution. For example, the payer terminal may generate a corresponding transaction processing command for a first selected electronic cash application, then send the transaction processing command to the first selected electronic cash application, and then receive a transaction processing response that is sent by the first electronic cash application after it is determined that the first electronic cash application can pay a corresponding payment sub-amount and the corresponding payment sub-amount is deducted from a corresponding balance, where the transaction processing response includes at least current deduction data. Then the payer terminal performs, for a next (a second, a third, . . . ) selected electronic cash application, an operation similar to the foregoing operation that is performed for the first selected electronic cash application. Still further For example, the payer terminal may generate corresponding transaction processing commands for all selected electronic cash applications at the same time, then sequentially send the corresponding transaction processing commands to the electronic cash applications, and finally, sequentially receive a transaction processing response that is sent by each electronic cash application after a corresponding payment sub-amount is deducted from a corresponding balance. All other possible execution methods that can be implemented in this way fall within the protection scope of the disclosure, and no further details are provided herein one by one.

Step 215. Select one of the at least one electronic cash applications to complete a current payment.

When there is at least one electronic cash application, whose balance is sufficient to independently cover the payment amount, in the electronic cash applications, one of the at least one electronic cash application is selected to complete the current payment. In a specific selection method, one electronic cash application may be selected, according to priorities of the electronic cash applications and/or a user indication, from the at least one electronic cash application whose balance is sufficient to independently cover the payment amount.

A method for implementing a payment by using one electronic cash application is similar to a method for implementing a payment by using multiple electronic cash applications. In both methods, transaction feasibility assessment and balance deduction processing need to be performed on an electronic cash application. For a specific operation, the action described in the foregoing steps 205 to 207 or steps 205 to 212 may be used, but in this case, a quantity of selected electronic cash applications changes to one.

It should be noted that for step 215 of selecting one electronic cash application to complete the payment, a specific implementation manner may be different from a foregoing case in which balances of multiple electronic cash applications are used to complete the payment. The payer terminal may set a selected electronic cash application, whose balance is sufficient, as being visible to the payee terminal. That is, the payee terminal may directly obtain selected related data of subsequent processing (for example, the offline data authentication or terminal risk management described above) from the selected electronic cash application, and no further details are provided herein.

In this embodiment, after a transaction request sent by a payee terminal is received, determining is first performed on a balance of each electronic cash application. When there is at least one electronic cash application whose balance is sufficient to independently complete a payment, a most proper electronic cash application may be selected according to a situation to implement the payment. When none of the electronic cash applications has a sufficient balance to independently complete the payment, multiple electronic cash applications, a sum of whose balances meets a payment amount, on a payer terminal are selected to implement the payment. An account number and deduction data that correspond to each selected electronic cash application are associated with a transaction sequence number. Then a payment response needs to be sent to the payee terminal for only once. Therefore, utilization of each electronic cash application can be improved, waste of balances of multiple electronic cash applications can be avoided, and user experience can be significantly improved.

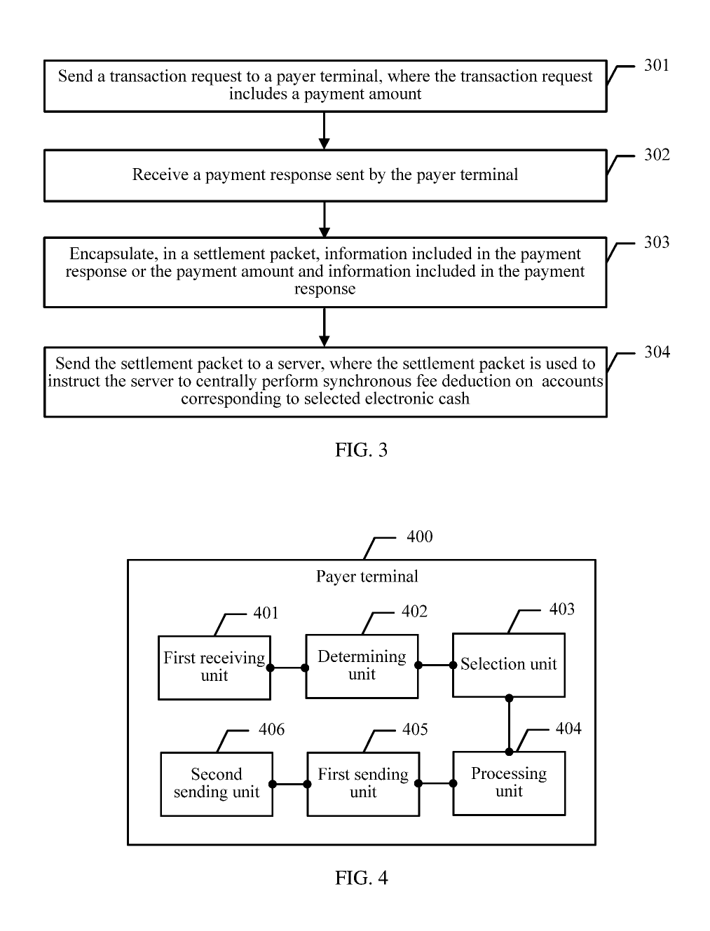

The foregoing describes a payment method provided in the disclosure from a side of a payer terminal. The following describes a payment method provided in the disclosure from a side of a payee terminal. Referring to FIG. 3, the payment method in this embodiment includes the following steps.

Step 301. Send a transaction request to a payer terminal, where the transaction request includes a payment amount.

After receiving the transaction request, the payer terminal performs determining according to a balance of each electronic cash application preconfigured on the payer terminal and the payment amount. When there is at least one electronic cash application whose balance is sufficient to independently complete a payment, the payer terminal may select a most proper electronic cash application according to a situation to implement the payment. When none of the electronic cash applications has a sufficient balance to independently complete the payment, the payer terminal selects multiple electronic cash applications, a sum of whose balances meets the payment amount, from the payer terminal to complete the payment. In this embodiment, descriptions are provided mainly by using an example in which the payer terminal selects multiple electronic cash applications, a sum of whose balances meets the payment amount, to complete a payment.

Step 302. Receive a payment response sent by the payer terminal.

The payment response includes a current transaction sequence number; or the payment response includes a current transaction sequence number, and an account number and deduction data that correspond to each selected electronic cash application and that are associated with the current transaction sequence number. Deduction data of each electronic cash application refers to data that is generated in a process in which the payer terminal performs deduction processing on each selected electronic cash application.

The payee terminal may associate the payment amount with information included in the payment response and store the payment amount, the information included in the payment response, and an association relationship between the payment amount and the information included in the payment response. The payment amount may be stored by the payee terminal, or may be sent by the payer terminal to the payee terminal. For example, if the payment response does not include the payment amount, and the payment amount is required when the settlement packet is reported to a server, the payee terminal may associate the payment amount required in a current transaction with information in the received payment response, to mark the current transaction by using the associated information, so as to encapsulate, in a settlement packet, the payment amount and the information in the payment response according to the associated information before reporting settlement data to the server.

Step 303. Encapsulate, in a settlement packet, information included in the payment response or the payment amount and information included in the payment response.

Step 304. Send the settlement packet to a server, where the settlement packet is used to instruct the server to centrally perform synchronous fee deduction on accounts corresponding to the selected electronic cash.

Optionally, before the payee terminal receives the payment response sent by the payer terminal, the payee terminal may further receive a transaction response sent by the payer terminal, where the transaction response is used to indicate that the payer terminal can deduct a corresponding payment sub-amount from a balance of each selected electronic cash application. After the payee terminal receives the transaction response, the payee terminal may send a payment request to the payer terminal, where the payment request is used to request the payer terminal to use each selected electronic cash application to complete a current transaction.

The foregoing transaction response may include indication information, where the indication information may be used to indicate that the payer terminal needs to complete a current payment by using multiple electronic cash applications. After the payee terminal determines to allow the payer terminal to use multiple electronic cash applications to complete a payment in one transaction, the payee terminal sends a payment request to the payer terminal, to request the payer terminal to use each selected electronic cash application to complete a current transaction. Optionally, the indication information may be used to indicate that the payer terminal can pay the payment amount, and/or the payer terminal needs to complete a current payment by using multiple electronic cash applications. When the indication information is used to indicate that the payer terminal can pay the payment amount, the payee terminal may send a payment request, to request the payer terminal to continue to perform a subsequent procedure to complete the current transaction.

Usually, after completing the transaction, the payee terminal collects transaction data of a period of time (for example, one day), and then sends the transaction data to the server in a form of a settlement packet. After receiving the data, the server determines whether the transaction data is electronic cash transaction data. If yes, the server performs fee deduction on the corresponding electronic cash application, to ensure that an electronic cash account amount corresponding to an electronic cash application maintained by the server is consistent with a balance of an electronic cash application that is stored in the payer terminal.

If the payment response includes the current transaction sequence number, the payee terminal may encapsulate, in the settlement packet, the payment amount and the information included in the payment response, or certainly, may encapsulate, in the settlement packet, only the information included in the payment response. In this case, after receiving the current transaction sequence number sent by the payer terminal, and the account number and the deduction data that correspond to each selected electronic cash application, that are associated with the current transaction sequence number, and that are sent by the payer terminal, the server can centrally perform synchronous fee deduction on accounts corresponding to the electronic cash applications used in the current transaction, only by matching current transaction sequence numbers that are separately sent by the payee terminal and the payer terminal. If the payment response includes the current transaction sequence number, and the account number and the deduction data that correspond to each selected electronic cash application and that are associated with the current transaction sequence number, the payee terminal may encapsulate, in the settlement packet, the payment amount and the information included in the payment response, or may encapsulate, in the settlement packet, only the information included in the payment response. In this case, the server may directly and centrally perform, according to the settlement packet reported by the payee terminal, synchronous fee deduction on the accounts corresponding to the electronic cash applications used in the current transaction.

After centrally performing synchronous fee deduction on the accounts corresponding to the selected electronic cash, the server may send a settlement response to the payee terminal. The payee terminal receives the settlement response sent by the server.

The following describes a payer terminal provided in the disclosure. Referring to FIG. 4, the payer terminal 400 in this embodiment includes a first receiving unit 401 configured to receive a transaction request sent by a payee terminal, where the transaction request includes a payment amount; a determining unit 402 configured to determine whether there is at least one electronic cash application, whose balance is sufficient to cover the payment amount, in electronic cash applications preconfigured on the payer terminal, where the determining unit 402 is further configured to, if none of the electronic cash applications has a sufficient balance to independently cover the payment amount, determine whether there are at least two electronic cash applications, a sum of whose balances is greater than or greater than or equal to the payment amount, in the electronic cash applications; a selection unit 403 configured to, when there are at least two electronic cash applications, a sum of whose balances is greater than or greater than or equal to the payment amount, in the electronic cash applications, select a group of electronic cash applications, a sum of whose balances is greater than or greater than or equal to the payment amount, from the electronic cash applications; a processing unit 404 configured to allocate a corresponding payment sub-amount to each selected electronic cash application, and then deduct the corresponding payment sub-amount from a balance of each selected electronic cash application, until a sum of the deduction is equal to the payment amount, where the processing unit 404 is further configured to associate an account number and deduction data that correspond to each selected electronic cash application with a current transaction sequence number; and a first sending unit 405 configured to send a first payment response to the payee terminal, where the first payment response includes the current transaction sequence number, and the account number and the deduction data that correspond to each selected electronic cash application and that are associated with the current transaction sequence number; or a first sending unit 405 configured to send a second payment response to the payee terminal, where the second payment response includes the current transaction sequence number; and the payer terminal further includes a second sending unit 406, where the second sending unit 406 is configured to send, to a server, the current transaction sequence number, and the account number and the deduction data that correspond to each selected electronic cash application and that are associated with the current transaction sequence number, where the first payment response or the second payment response is used to instruct the payee terminal to generate, according to information included in the first payment response or in the second payment response, a settlement packet used to instruct the server to centrally perform synchronous fee deduction on accounts corresponding to the selected electronic cash applications.

In a specific implementation, the payee terminal may be a POS machine, or may be another intelligent terminal having a money collection function, such as a mobile phone or a tablet computer. The first receiving unit 401 receives the transaction request sent by the payee terminal, where the transaction request includes the payment amount.

The determining unit 402 determines whether there is at least one electronic cash application, whose balance is sufficient to cover the payment amount, in the electronic cash applications preconfigured on the payer terminal, and if yes, ends the processing, or if not, the determining unit 402 continues to determine whether there are at least two electronic cash applications, a sum of whose balances is greater than or greater than or equal to the payment amount, in the electronic cash applications.

In a specific implementation, a balance of each electronic cash application may be obtained in the following manners. In a first manner, the payer terminal may maintain a list of electronic cash applications in advance. The list of electronic cash applications includes an electronic cash balance corresponding to each electronic cash application. When the payer terminal is used, the list of electronic cash applications is directly queried to obtain the balance of each electronic cash application. In a second manner, each time the first receiving unit 401 receives a transaction request sent by the payee terminal, the payer terminal obtains the balance from each electronic cash application in real time.

There is at least one electronic cash application whose balance is sufficient to cover the payment amount may be a balance of at least one of these electronic cash applications that is greater than or greater than or equal to the payment amount; or may be a balance of at least one of these electronic cash applications that is greater than or greater than or equal to the payment amount, and a single transaction limit (that is, a maximum amount that can be paid in a single offline transaction) of the at least one electronic cash application that is greater than or greater than or equal to the payment amount.

Correspondingly, none of the electronic cash applications has a sufficient balance to independently cover the payment amount may be a balance of any electronic cash application that is less than or less than or equal to the payment amount; or may be a balance of any electronic cash application that is greater than or greater than or equal to the payment amount, but a single transaction limit (that is, a maximum amount that can be paid in a single offline transaction) of any electronic cash application that is less than or less than or equal to the payment amount.

In a specific implementation, an implementation manner in which the determining unit 402 determines whether there is at least one electronic cash application, whose balance is sufficient to cover the payment amount, in the electronic cash applications preconfigured on the payer terminal is the same as the descriptions of the embodiment shown in FIG. 1, and the details are not described herein again. If a result of the determining by the determining unit 402 is that there are at least two electronic cash applications, a sum of whose balances is greater than or greater than or equal to the payment amount, in the electronic cash applications, the selection unit 403 selects a group of electronic cash applications, a sum of whose balances is greater than or greater than or equal to the payment amount, from the electronic cash applications, and the processing unit 404 deducts the corresponding payment sub-amount from the balance of each electronic cash application selected by the selection unit 403, until the sum of the deduction is equal to the payment amount. The first sending unit 405 sends a first payment response to the payee terminal, where the first payment response includes the current transaction sequence number, and the account number and the deduction data that correspond to each selected electronic cash application and that are associated with the current transaction sequence number. Alternatively, the first sending unit 405 sends a second payment response to the payee terminal, where the second payment response includes the current transaction sequence number; and the second sending unit 406 sends, to the server, the current transaction sequence number, and the account number and the deduction data that correspond to each selected electronic cash application and that are associated with the current transaction sequence number.

The first payment response is used to instruct the payee terminal to generate, according to information included in the first payment response, a settlement packet used to instruct the server to centrally perform synchronous fee deduction on accounts corresponding to the selected electronic cash applications. The second payment response is used to instruct the payee terminal to generate, according to information included in the second payment response, a settlement packet used to instruct the server to centrally perform synchronous fee deduction on the accounts corresponding to the selected electronic cash applications.

It should be noted that the first payment response or the second payment response may further include at least the payment amount. If the first payment response or the second payment response does not include the payment amount, but the payee terminal needs to add the payment amount to the settlement packet, the payee terminal may automatically add the payment amount required in the current transaction to the settlement packet. The payer terminal may clearly notify, by using the single first or second payment response, the payee terminal that multiple electronic cash applications are used in the current transaction. In a case in which the payer terminal sends the second payment response to the payee terminal, the payer terminal needs to send, to the server, the current transaction sequence number, and the account number and the deduction data that correspond to each of the multiple electronic cash applications that are associated with the current transaction sequence number, in order to ensure that the server clearly learns the electronic cash applications that are used by the payer terminal in the current transaction, so that the server centrally performs synchronous fee deduction on accounts corresponding to the electronic cash applications used in the current transaction.

When the processing unit 404 performs successive deduction from the balance of each electronic cash application selected by the selection unit 403, it needs to be ensured that a deduction amount each time does not exceed (that is, is less than or less than or equal to) a balance corresponding to each electronic cash application. Alternatively, it needs to be ensured that a deduction amount each time does not exceed a balance corresponding to each electronic cash application and a corresponding single transaction limit. Alternatively, it needs to be ensured that a deduction amount each time does not exceed a balance corresponding to each electronic cash application and a corresponding single transaction limit, and a balance after the deduction is not less than (that is, greater than or greater than or equal to) a bottom limit for credit for load/recharging (that is, a minimum balance that triggers credit for load/recharging of the balance of the electronic cash application) that corresponds to each electronic cash application.

In addition, the payer terminal 400 in this embodiment may further be configured to perform other steps in the method embodiment corresponding to FIG. 1, and the details are described herein again.

In this embodiment, after the first receiving unit receives a transaction request that is sent by a payee terminal and that includes a payment amount, the determining unit first performs determining on a balance of each electronic cash application. When there is at least one electronic cash application whose balance is sufficient to independently complete a payment, the selection unit may select a most proper electronic cash application according to a situation to implement the payment. When none of the electronic cash applications has a sufficient balance to independently complete the payment, the selection unit selects multiple electronic cash applications, a sum of whose balances meets the payment amount, on the payer terminal to implement the payment. An account number and deduction data that correspond to each selected electronic cash application are associated with a transaction sequence number. Then a payment response needs to be sent to the payee terminal for only once. Therefore, utilization of each electronic cash application can be improved, waste of balances of multiple electronic cash applications can be avoided, and user experience can be significantly improved.

The following describes another embodiment of a payer terminal of the disclosure. Referring to FIG. 5, the payer terminal 500 in this embodiment includes a first receiving unit 501 configured to receive a transaction request sent by a payee terminal, where the transaction request includes a payment amount; a determining unit 502 configured to determine whether there is at least one electronic cash application, whose balance is sufficient to cover the payment amount, in electronic cash applications preconfigured on the payer terminal.

In a specific implementation, a manner of acquiring the balance of each electronic cash application, an understanding of a case in which a balance of at least one electronic cash application is sufficient to cover the payment amount, and an implementation manner in which the determining unit 502 determines whether there is at least one electronic cash application, whose balance is sufficient to cover the payment amount, in the electronic cash applications preconfigured on the payer terminal are all the same as those described in the embodiment shown in FIG. 1, and the details are not described herein again.

The determining unit 502 is further configured to, if none of the electronic cash applications has a sufficient balance to independently cover the payment amount, determine whether there are at least two electronic cash applications, a sum of whose balances is greater than or greater than or equal to the payment amount, in the electronic cash applications; a selection unit 503 configured to, when there are at least two electronic cash applications, a sum of whose balances is greater than or greater than or equal to the payment amount, in the electronic cash applications, select a group of electronic cash applications, a sum of whose balances is greater than or greater than or equal to the payment amount, from the electronic cash applications; a processing unit 504 configured to generate a transaction processing command for each selected electronic cash application, where each transaction processing command includes a payment sub-amount allocated to a corresponding electronic cash application by the payer terminal, and the payment sub-amount is less than or less than or equal to a balance of the corresponding electronic cash application; send the corresponding transaction processing command to each selected electronic cash application; and receive a transaction processing response returned by each selected electronic cash application, where each transaction processing response is used to indicate that the corresponding electronic cash application can pay the payment sub-amount, where the processing unit 504 is further configured to generate a settlement command for each selected electronic cash application, where each settlement command is used to request a corresponding electronic cash application to deduct a corresponding payment sub-amount from a respective balance; send the corresponding settlement command to each selected electronic cash application; and receive a settlement response returned by each selected electronic cash application, where each settlement response includes deduction data of a corresponding electronic cash application, and the processing unit 504 is further configured to associate an account number and deduction data that correspond to each selected electronic cash application with a current transaction sequence number; and a first sending unit 505 configured to send a first payment response to the payee terminal, where the first payment response includes the current transaction sequence number, and the account number and the deduction data that correspond to each selected electronic cash application and that are associated with the current transaction sequence number; or a first sending unit 505 configured to send a second payment response to the payee terminal, where the second payment response includes the current transaction sequence number; and a second sending unit 506 configured to send, to a server such as, for example, a second receiving unit 507, the current transaction sequence number, and the account number and the deduction data that correspond to each selected electronic cash application and that are associated with the current transaction sequence number, where the first payment response or the second payment response is used to instruct the payee terminal to generate, according to information included in the first payment response or in the second payment response, a settlement packet used to instruct the server to centrally perform synchronous fee deduction on accounts corresponding to the selected electronic cash applications.

For ease of understanding, the following describes a process of interaction between the units in the payer terminal 500 in this embodiment by using a specific embodiment, which is as follows.

When the payee terminal initiates the transaction request to the payer terminal, the first receiving unit 501 receives the transaction request sent by the payee terminal, where the transaction request includes the payment amount. The determining unit 502 determines whether there is at least one electronic cash application, whose balance is sufficient to cover the payment amount, in the electronic cash applications preconfigured on the payer terminal.

If none of the electronic cash applications has a sufficient balance to independently cover the payment amount, the determining unit 502 continues to determine whether there are at least two electronic cash applications, a sum of whose balances is greater than or greater than or equal to the payment amount, in the electronic cash applications. If not, the processing is ended. If yes, the selection unit 503 selects a group of electronic cash applications, a sum of whose balances is greater than or greater than or equal to the payment amount, from the electronic cash applications.

A specific selection method may be selecting a group of electronic cash applications from the electronic cash applications according to any one or a combination of any multiple of priorities of the electronic cash applications, a maximum usage quantity of electronic cash applications in one transaction, or a user indication, where the group of electronic cash applications include at least two electronic cash applications, a sum of whose balances is greater than or greater than or equal to the payment amount.

Next, the processing unit 504 performs transaction feasibility assessment on each electronic cash application selected by the selection unit 503, which is as follows.

The processing unit 504 generates a transaction processing command for each electronic cash application selected by the selection unit 503, where each transaction processing command includes a payment sub-amount allocated to a corresponding electronic cash application by the payer terminal, and the payment sub-amount is less than or less than or equal to a balance of the corresponding electronic cash application; sends the corresponding transaction processing command to each selected electronic cash application; and receives a transaction processing response returned by each selected electronic cash application.

The transaction processing response is used to indicate that the corresponding electronic cash application can pay the payment sub-amount, which may be the balance of each electronic cash application is greater than or greater than or equal to the corresponding payment sub-amount; or may be the balance of each electronic cash application is greater than or greater than or equal to the corresponding payment sub-amount, and a single transaction limit of each electronic cash application is greater than or greater than or equal to the corresponding payment sub-amount.

Optionally, each transaction processing response includes location entry information of related data of the corresponding electronic cash application, so that the payer terminal obtains the related data from the corresponding electronic cash application by using the location entry information, to perform an operation, such as offline data authentication or terminal risk management, that is defined in a PBOC standard, and no further details are provided herein.

After transaction feasibility assessment is performed on each selected electronic cash application, the first sending unit 505 returns a transaction response to the payee terminal, where the transaction response is used to indicate that the payer terminal can pay the payment amount, and/or the transaction response is used to indicate that the payer terminal can deduct the corresponding payment sub-amount from the balance of each selected electronic cash application. The first receiving unit 501 receives a payment request sent by the payee terminal, and the processing unit 504 deducts the corresponding payment sub-amount from each selected electronic cash application.

The processing unit 504 generates a settlement command for each selected electronic cash application, where each settlement command includes a payment sub-amount of each electronic cash application, and each settlement command is used to request each electronic cash application to deduct the corresponding payment sub-amount from a respective balance, sends a corresponding settlement command to each selected electronic cash application, and receives a settlement response returned by each selected electronic cash application, where each settlement response includes deduction data corresponding to a corresponding electronic cash application.

Optionally, before the first sending unit 505 returns the transaction response to the payee terminal, or before the processing unit 504 sends the corresponding settlement command to each selected electronic cash application, the processing unit 504 may obtain corresponding related data from each selected electronic cash application, for an operation, such as offline data authentication or terminal risk management, that is defined for a card (such as a debit card or a credit card) and a payee terminal (such as a POS machine) in a PBOC standard, and no further details are provided herein. Similarly, before sending the payment request to the payer terminal, the payee terminal may obtain corresponding related data from the payer terminal, for an operation, such as offline data authentication or terminal risk management, that is defined in a PBOC standard, and no further details are provided herein.

Optionally, the process in which the processing unit 504 generates a settlement command, sends the settlement command, and receives a settlement response may be combined, for execution, in the process in which the processing unit 504 generates a transaction processing command, sends the transaction processing command, and receives a transaction processing response. That is, the processing unit 504 sends a corresponding transaction processing command to each selected electronic cash application; after it is determined that each selected electronic cash can pay a corresponding payment sub-amount, the corresponding payment sub-amount is directly deducted from a corresponding balance; a transaction processing response is then returned to the payer terminal, where the transaction processing response may include location entry information of related data of the corresponding electronic cash application, and current deduction data; and after the processing unit 504 receives the transaction processing response returned by each selected electronic cash application, the payer terminal may obtain corresponding related data from each selected electronic cash by using a method similar to the foregoing method, for an operation, such as offline data authentication or terminal risk management, that is defined in a PBOC standard, and no further details are provided herein.

In this case, it should be noted that, the data obtained by the payer terminal from each selected electronic cash application is different from the data obtained by the payee terminal from the payer terminal. Location entry information of related data of each electronic cash application in the former data is visible to the payer terminal, while location entry information of related data of the payer terminal in the latter data is visible to the payee terminal.

After deducting the corresponding payment sub-amount from the balance of each selected electronic cash application, until the sum of the deduction is equal to the payment amount, the processing unit 504 associates the account number and the deduction data that correspond to each selected electronic cash application with the current transaction sequence number.

The first sending unit 505 sends a first payment response to the payee terminal, where the first payment response includes the current transaction sequence number, and the account number and the deduction data that correspond to each selected electronic cash application and that are associated with the current transaction sequence number; or the first sending unit 505 sends a second payment response to the payee terminal, where the second payment response includes the current transaction sequence number; and the second sending unit 506 sends, to the server, the current transaction sequence number, and the account number and the deduction data that correspond to each selected electronic cash application and that are associated with the current transaction sequence number.

The first payment response or the second payment response is used to instruct the payee terminal to generate, according to information included in the first payment response or in the second payment response, a settlement packet used to instruct the server to centrally perform synchronous fee deduction on accounts corresponding to the selected electronic cash applications.

It should be noted that the first payment response or the second payment response may further include at least the payment amount. If the first payment response or the second payment response does not include the payment amount, but the payee terminal needs to add the payment amount to the settlement packet, the payee terminal may automatically add the payment amount required in the current transaction to the settlement packet. The payer terminal may clearly notify, by using the single first or second payment response, the payee terminal that multiple electronic cash applications are used in the current transaction. In a case in which the payer terminal sends the second payment response to the payee terminal, the payer terminal needs to send, to the server, the current transaction sequence number, and the account number and the deduction data that correspond to each of the multiple electronic cash applications that are associated with the current transaction sequence number, in order to ensure that the server clearly learns the electronic cash applications that are used by the payer terminal in the current transaction, so that the server centrally performs synchronous fee deduction on accounts corresponding to the electronic cash applications used in the current transaction.

Deduction data of each electronic cash application refers to data that is generated in a process in which the payer terminal performs deduction processing on each selected electronic cash application. Usually, after completing the transaction, the payee terminal collects transaction data of a period of time (for example, one day), and then sends the transaction data to the server in a form of a settlement packet. After receiving the data, the server determines whether the transaction data is electronic cash transaction data. If yes, the server performs fee deduction on the corresponding electronic cash application, to ensure that an electronic cash account amount corresponding to an electronic cash application maintained by the server is consistent with a balance of an electronic cash application that is stored in the payer terminal.

It should be noted that the second sending unit 506 may send, to the server by using a network such as a mobile network or a wireless network, the current transaction sequence number, and the account number and the deduction data that correspond to each selected electronic cash application and that are associated with the current transaction sequence number; and the payee terminal may also send the settlement packet to the server by using a network such as a mobile network or a wireless network.

When a result of the determining by the determining unit 502 is that there is at least one electronic cash application, whose balance is sufficient to independently cover the payment amount, in the electronic cash applications, the selection unit 503 selects one of the at least one electronic cash application to complete the current payment. In a specific selection method, one electronic cash application may be selected, according to priorities of the electronic cash applications and/or a user indication, from the at least one electronic cash application whose balance is sufficient to independently cover the payment amount.

A method for implementing a payment by using one electronic cash application is similar to a method for implementing a payment by using multiple electronic cash applications. In both methods, transaction feasibility assessment and balance deduction processing need to be performed on an electronic cash application. For a specific operation, refer to the content described above, but in this case, a quantity of selected electronic cash applications changes to one.

It should be noted that for selecting one electronic cash application to complete the payment, a specific implementation manner may be different from a foregoing case in which balances of multiple electronic cash applications are used to complete the payment. The payer terminal may set a selected electronic cash application, whose balance is sufficient, as being visible to the payee terminal. That is, the payee terminal may directly obtain selected related data of subsequent processing (for example, the offline data authentication or terminal risk management described above) from the selected electronic cash application, and no further details are provided herein.

In addition, the payer terminal 500 in this embodiment may further be configured to perform other steps in the method embodiment corresponding to FIG. 2, and the details are not described herein again.

In this embodiment, after the first receiving unit receives a transaction request sent by a payee terminal, the determining unit first performs determining on a balance of each electronic cash application. When there is at least one electronic cash application whose balance is sufficient to independently complete a payment, the selection unit may select a most proper electronic cash application according to a situation to implement the payment. When none of the electronic cash applications has a sufficient balance to independently complete the payment, the selection unit selects multiple electronic cash applications, a sum of whose balances meets the payment amount, on the payer terminal to implement the payment. An account number and deduction data that correspond to each selected electronic cash application are associated with a transaction sequence number. Then a payment response needs to be sent to the payee terminal for only once. Therefore, utilization of each electronic cash application can be improved, waste of balances of multiple electronic cash applications can be avoided, and user experience can be significantly improved.

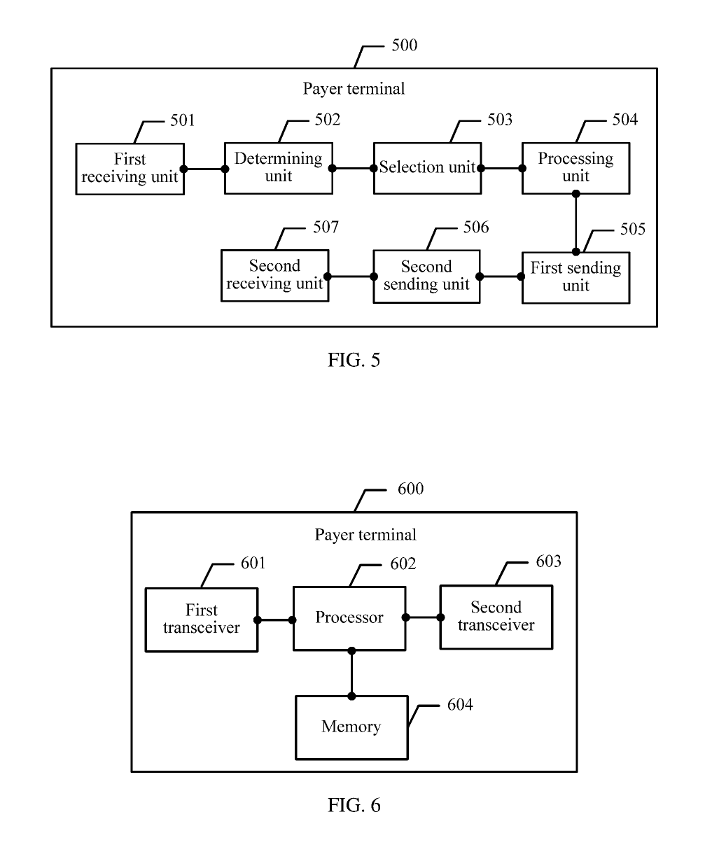

The following describes another embodiment of a payer terminal of the disclosure. Referring to FIG. 6, the payer terminal 600 in this embodiment includes a first transceiver 601, a processor 602, a second transceiver 603, and a memory 604. The memory 604 is configured to store program code. The processor 602 is configured to execute the program code stored in the memory 604 to control the first transceiver 601 to receive a transaction request sent by a payee terminal, where the transaction request includes a payment amount.

The processor 602 is further configured to determine whether there is at least one electronic cash application, whose balance is sufficient to cover the payment amount, in electronic cash applications preconfigured on the payer terminal.

In a specific implementation, a manner of acquiring the balance of each electronic cash application, an understanding of a case in which a balance of at least one electronic cash application is sufficient to cover the payment amount, and an implementation manner in which the processor 602 determines whether there is at least one electronic cash application, whose balance is sufficient to cover the payment amount, in the electronic cash applications preconfigured on the payer terminal are all the same as those described in the embodiment shown in FIG. 1, and the details are not described herein again.

The processor 602 is further configured to, if none of the electronic cash applications has a sufficient balance to independently cover the payment amount, determine whether there are at least two electronic cash applications, a sum of whose balances is greater than or greater than or equal to the payment amount, in the electronic cash applications. The processor 602 is further configured to, when there are at least two electronic cash applications, a sum of whose balances is greater than or greater than or equal to the payment amount, in the electronic cash applications, select a group of electronic cash applications, a sum of whose balances is greater than or greater than or equal to the payment amount, from the electronic cash applications; deduct a corresponding payment sub-amount from a balance of each selected electronic cash application, until a sum of the deduction is equal to the payment amount; and associate an account number and deduction data that correspond to each selected electronic cash application with a current transaction sequence number.

The processor 602 is further configured to control the first transceiver 601 to send a first payment response to the payee terminal, where the first payment response includes the current transaction sequence number, and the account number and the deduction data that correspond to each selected electronic cash application and that are associated with the current transaction sequence number.

Alternatively, the processor 602 is further configured to control the first transceiver 601 to send a second payment response to the payee terminal, where the second payment response includes the current transaction sequence number, and control the second transceiver 603 to send, to a server, the current transaction sequence number, and the account number and the deduction data that correspond to each selected electronic cash application and that are associated with the current transaction sequence number.

The first payment response or the second payment response is used to instruct the payee terminal to generate, according to information included in the first payment response or in the second payment response, a settlement packet used to instruct the server to centrally perform synchronous fee deduction on accounts corresponding to the selected electronic cash applications.

In a specific implementation, data interaction between the payer terminal and the payee terminal in this embodiment may be implemented by using a near field communication (NFC) technology or another radio frequency (RF) communication technology. The first transceiver 601 may be integrated into an NFC chip or another RF circuit (for example, whose working frequency is 13.56 Megahertz (MHz). The first transceiver 601 is mainly configured to communicate with the payee terminal. The processor in this embodiment may be integrated into a central processing unit (CPU) of the payer terminal (for example, a mobile phone or a tablet computer), or is a CPU of the payer terminal, or may be a secure element (SE), in which a selected electronic cash application is located, in the payer terminal, or a processor in a near field communication execution environment (NFCEE).

Optionally, the processor 602 is further configured to, after controlling the second transceiver 603 to send, to the server, the current transaction sequence number, and the account number and the deduction data that correspond to each selected electronic cash application and that are associated with the current transaction sequence number, control the second transceiver 603 to receive a response returned by the server, where the response is used to indicate a result of synchronous fee deduction that is performed on a corresponding account of an electronic cash application by the server according to the current transaction sequence number, and the associated account number and the associated deduction data that correspond to each electronic cash application.

Optionally, the selecting, by the processor 602, a group of electronic cash applications, a sum of whose balances is greater than or greater than or equal to the payment amount, from the electronic cash applications includes selecting, by the processor 602, a group of electronic cash applications from the electronic cash applications according to any one or a combination of any multiple of priorities of the electronic cash applications, a maximum usage quantity of electronic cash applications in one transaction, or a user indication, where the group of electronic cash applications include at least two electronic cash applications, a sum of whose balances is greater than or greater than or equal to the payment amount.

Optionally, the allocating, by the processor 602, a corresponding payment sub-amount to each selected electronic cash application includes generating, by the processor 602, a transaction processing command for each selected electronic cash application, where each transaction processing command includes a payment sub-amount allocated to a corresponding electronic cash application by the payer terminal, and the payment sub-amount is less than or less than or equal to a balance of the corresponding electronic cash application; sending, by the processor 602, the corresponding transaction processing command to each selected electronic cash application; and receiving, by the processor 602, a transaction processing response returned by each selected electronic cash application, where each transaction processing response is used to indicate that the corresponding electronic cash application can pay the payment sub-amount.

Optionally, the deducting, by the processor 602, a corresponding payment sub-amount from a balance of each selected electronic cash application, until a sum of the deduction is equal to the payment amount includes generating, by the processor 602, a settlement command for each selected electronic cash application, where each settlement command is used to request a corresponding electronic cash application to deduct a corresponding payment sub-amount from a respective balance; sending, by the processor 602, the corresponding settlement command to each selected electronic cash application; and receiving, by the processor 602, a settlement response returned by each selected electronic cash application, where each settlement response includes deduction data of a corresponding electronic cash application.

Optionally, the first transceiver 601 is further configured to, before the processor 602 generates the settlement command for each selected electronic cash application, or after the processor 602 receives the settlement response returned by each selected electronic cash application, return a transaction response to the payee terminal, where the transaction response is used to indicate that the payer terminal can pay the payment amount; and the first transceiver 601 is further configured to receive a payment request sent by the payee terminal.

Optionally, the allocating, by the processor 601, a corresponding payment sub-amount to each selected electronic cash application, and then deducting the corresponding payment sub-amount from a balance of each selected electronic cash application, until a sum of the deduction is equal to the payment amount includes generating, by the processor 601, a transaction processing command for each selected electronic cash application, where each transaction processing command includes a payment sub-amount allocated to a corresponding electronic cash application by the payer terminal, and the payment sub-amount is less than or less than or equal to a balance of the corresponding electronic cash application; sending, by the processor 601, the corresponding transaction processing command to each selected electronic cash application; and receiving, by the processor 601, a transaction processing response returned by each selected electronic cash application, where each transaction processing response is used to carry deduction data of a corresponding electronic cash application.

Optionally, the processor 601 is further configured to, when a result of the determining is that there is at least one electronic cash application, whose balance is sufficient to cover the payment amount, in the electronic cash applications preconfigured on the payer terminal, select one of the at least one electronic cash application to complete a current payment.

Optionally, the selecting, by the processor 601, one of the at least one electronic cash application includes selecting, by the processor 601 according to priorities of the electronic cash applications and/or a user indication, one electronic cash application from the at least one electronic cash application whose balance is sufficient to independently cover the payment amount.

In a specific implementation, the second transceiver 603 may send and receive data by using a wireless network such as a mobile network or Wireless Fidelity (WI-FI). The second transceiver 603 is mainly configured to communicate with the server.

It should be noted that the payer terminal 600 in this embodiment may further be configured to implement another function in the foregoing apparatus embodiments, and no further details are provided herein.

In this embodiment, after the first transceiver receives a transaction request sent by a payee terminal, the processor first performs determining on a balance of each electronic cash application. When there is at least one electronic cash application whose balance is sufficient to independently complete a payment, the processor may select a most proper electronic cash application according to a situation to implement the payment. When none of the electronic cash applications has a sufficient balance to independently complete the payment, the processor selects multiple electronic cash applications, a sum of whose balances meets a payment amount, on the payer terminal to implement the payment. An account number and deduction data that correspond to each selected electronic cash application are associated with a transaction sequence number. Then a payment response needs to be sent to the payee terminal for only once. Therefore, utilization of each electronic cash application can be improved, waste of balances of multiple electronic cash applications can be avoided, and user experience can be significantly improved.

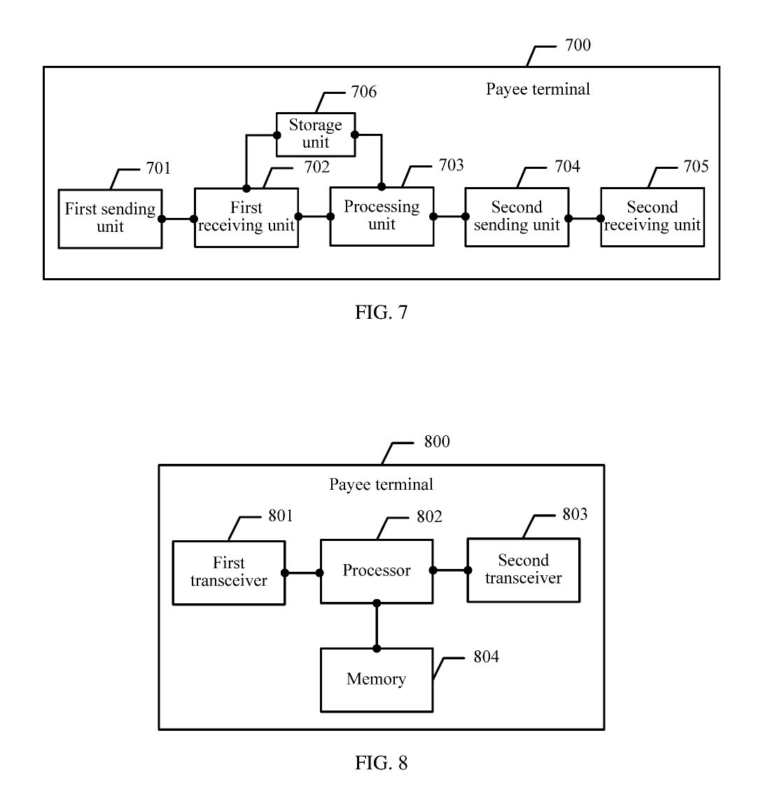

The following describes a payee terminal provided in an embodiment of the disclosure. Referring to FIG. 7, the payee terminal in this embodiment includes a first sending unit 701 configured to send a transaction request to a payer terminal, where the transaction request includes a payment amount; a first receiving unit 702 configured to receive a payment response sent by the payer terminal, where the payment response includes the current transaction sequence number; or the payment response includes the current transaction sequence number, and an account number and deduction data that correspond to each selected electronic cash application and that are associated with the current transaction sequence number; a processing unit 703 configured to encapsulate, in a settlement packet, information included in the payment response or the payment amount and information included in the payment response; and a second sending unit 704 configured to send the settlement packet to a server, where the settlement packet is used to instruct the server to centrally perform synchronous fee deduction on accounts corresponding to the selected electronic cash.

In addition, the first receiving unit 702 is further configured to, before receiving the payment response sent by the payer terminal, receive a transaction response sent by the payer terminal, where the transaction response is used to indicate that the payer terminal can deduct a corresponding payment sub-amount from a balance of each selected electronic cash application.

The first sending unit 701 is further configured to send a payment request to the payer terminal, where the payment request is used to request the payer terminal to use each selected electronic cash application to complete a current transaction.

The payee terminal further includes a storage unit 706 configured to, after the first receiving unit 702 receives the payment response sent by the payer terminal, associate the payment amount with the information included in the payment response and store the payment amount, the information included in the payment response, and an association relationship between the payment amount and the information included in the payment response.

The payee terminal further includes a second receiving unit 705 configured to, after the second sending unit 704 sends the settlement packet to the server, receive a settlement response sent by the server, where the settlement response is used to indicate that the server has centrally performed synchronous fee deduction on the accounts corresponding to the electronic cash applications associated with the current transaction sequence number.

The following describes interaction between the units in the payee terminal 700 in detail, which is as follows.

First, the first sending unit 701 sends a transaction request to a payer terminal. After receiving the transaction request, the payer terminal performs determining according to a balance of each electronic cash application preconfigured on the payer terminal and a payment amount. When there is at least one electronic cash application whose balance is sufficient to independently complete a payment, the payer terminal may select a most proper electronic cash application according to a situation to implement the payment. When none of the electronic cash applications has a sufficient balance to independently complete the payment, the payer terminal selects multiple electronic cash applications, a sum of whose balances meets the payment amount, on the payer terminal to complete the payment, and sends a transaction response to the payee terminal. In this embodiment, descriptions are provided mainly by using an example in which the payer terminal selects multiple electronic cash applications, a sum of whose balances meets the payment amount, to complete a payment.

The first receiving unit 702 receives the transaction response sent by the payer terminal, where the transaction response is used to indicate that the payer terminal can deduct a corresponding payment sub-amount from a balance of each selected electronic cash application. Then the first sending unit 701 sends a payment request to the payer terminal, where the payment request is used to request the payer terminal to use each selected electronic cash application to complete a current transaction.

The transaction response may include indication information, where the indication information may be used to indicate that the payer terminal needs to complete a current payment by using multiple electronic cash applications. After the payee terminal determines to allow the payer terminal to use multiple electronic cash applications to complete a payment in one transaction, the first sending unit 701 sends a payment request to the payer terminal, to request the payer terminal to use each selected electronic cash application to complete a current transaction. Optionally, the indication information may be used to indicate that the payer terminal can pay the payment amount, and/or the payer terminal needs to complete a current payment by using multiple electronic cash applications. When the indication information is used to indicate that the payer terminal can pay the payment amount, the payee terminal may send a payment request, to request the payer terminal to continue to perform a subsequent procedure to complete the current transaction.

After the payer terminal deducts a corresponding payment sub-amount from a balance of a selected electronic cash application, until a sum of the deduction is equal to the payment amount, a payment response is sent to the payee terminal. The first receiving unit 702 receives the payment response sent by the payer terminal, where the payment response includes a current transaction sequence number; or the payment response includes a current transaction sequence number, and an account number and deduction data that correspond to each selected electronic cash application and that are associated with the current transaction sequence number. Deduction data of each electronic cash application refers to data that is generated in a process in which the payer terminal performs deduction processing on each selected electronic cash application. The storage unit 706 may associate the payment amount with information included in the payment response and store the payment amount, the information included in the payment response, and an association relationship between the payment amount and the information included in the payment response. The payment amount may be stored by the payee terminal, or may be sent by the payer terminal to the payee terminal. For example, if the payment response does not include the payment amount, and the payment amount is required when the settlement packet is reported to the server, the payee terminal may associate the payment amount required in the current transaction with information in the received payment response, to mark the current transaction by using the associated information, so as to encapsulate, in a settlement packet, the payment amount and the information in the payment response according to the associated information before reporting settlement data to the server.

The processing unit 703 encapsulates, in a settlement packet, the payment amount and the information included in the payment response. The second sending unit 704 sends the settlement packet to the server, where the settlement packet is used to instruct the server to centrally perform synchronous fee deduction on the accounts corresponding to the selected electronic cash.

Usually, after completing the transaction, the payee terminal collects transaction data of a period of time (for example, one day), and then sends the transaction data to the server in a form of a settlement packet. After receiving the data, the server determines whether the transaction data is electronic cash transaction data. If yes, the server performs fee deduction on the corresponding electronic cash application, to ensure that an electronic cash account amount corresponding to an electronic cash application maintained by the server is consistent with a balance of an electronic cash application that is stored in the payer terminal.

If the payment response includes the current transaction sequence number, the processing unit 703 may encapsulate, in the settlement packet, the payment amount and the information included in the payment response, or certainly, may encapsulate, in the settlement packet, only the information included in the payment response. In this case, after receiving the current transaction sequence number sent by the payer terminal, and the account number and the deduction data that correspond to each selected electronic cash application, that are associated with the current transaction sequence number, and that are sent by the payer terminal, the server can centrally perform synchronous fee deduction on accounts corresponding to the electronic cash applications used in the current transaction, only by matching current transaction sequence numbers that are separately sent by the payee terminal and the payer terminal. If the payment response includes the current transaction sequence number, and the account number and the deduction data that correspond to each selected electronic cash application and that are associated with the current transaction sequence number, the processing unit 703 may encapsulate, in the settlement packet, the payment amount and the information included in the payment response, or may encapsulate, in the settlement packet, only the information included in the payment response. In this case, the server may directly and centrally perform, according to the settlement packet reported by the payee terminal, synchronous fee deduction on the accounts corresponding to the electronic cash applications used in the current transaction.

After centrally performing synchronous fee deduction on the accounts corresponding to the selected electronic cash, the server may send a settlement response to the payee terminal. The second receiving unit 705 receives the settlement response sent by the server.

Referring to FIG. 8, another embodiment of a payee terminal of the disclosure includes a first transceiver 801, a processor 802, a second transceiver 803, and a memory 804. The memory 804 is configured to store program code. The processor 802 is configured to execute the program code stored in the memory 804 to control the first transceiver 801 to send a transaction request to a payer terminal, where the transaction request includes a payment amount; and receive a payment response sent by the payer terminal, where the payment response includes the current transaction sequence number; or the payment response includes the current transaction sequence number, and an account number and deduction data that correspond to each selected electronic cash application and that are associated with the current transaction sequence number.

In a specific implementation, data interaction between the payer terminal and the payee terminal in this embodiment may be implemented by using an NFC technology or another RF communication technology. The first transceiver 801 may be integrated into an NFC chip or another RF circuit (for example, whose working frequency is 13.56 MHz). The first transceiver 801 is mainly configured to communicate with the payer terminal. The processor in this embodiment may be integrated into a CPU of the payee terminal (for example, a POS machine or a tablet computer), or is a CPU of the payee terminal, or may be a SE, in which a read/write application used to execute a payment transaction is located, in the payee terminal or a processor in an NFCEE.

The processor 802 is further configured to encapsulate, in a settlement packet, the payment amount and information included in the payment response.

The processor 802 is further configured to control the second transceiver 803 to send the settlement packet to a server, where the settlement packet is used to instruct the server to centrally perform synchronous fee deduction on accounts corresponding to the selected electronic cash.

Optionally, the first transceiver 801 is further configured to, before receiving the payment response sent by the payer terminal, receive a transaction response sent by the payer terminal, where the transaction response is used to indicate that the payer terminal can deduct a corresponding payment sub-amount from a balance of each selected electronic cash application.

The first transceiver 801 is further configured to send a payment request to the payer terminal, where the payment request is used to request the payer terminal to use each selected electronic cash application to complete a current transaction.

Optionally, the memory 804 is configured to, after the first transceiver 801 receives the payment response sent by the payer terminal, associate the payment amount with the information included in the payment response and store the payment amount, the information included in the payment response, and an association relationship between the payment amount and the information included in the payment response.

Optionally, the second transceiver 803 is further configured to, after sending the settlement packet to the server, receive a settlement response sent by the server, where the settlement response is used to indicate that the server has centrally performed synchronous fee deduction on the accounts corresponding to the electronic cash applications associated with the current transaction sequence number.

In a specific implementation, the second transceiver 803 may send and receive data by using a wireless network such as a mobile network or WI-FI. The second transceiver 803 is mainly configured to communicate with the server. It should be noted that the payee terminal 800 in this embodiment may further be configured to implement another function in the foregoing apparatus embodiments, and no further details are provided herein.

In addition, the apparatus embodiments described above are merely examples. The units that are described as separate components may be or may not be physically separated. The components displayed as units may be or may not be physical units, that is, may be located in a same place, or may be scattered on multiple network units. Some or all of the modules may be selected according to actual needs to achieve the objectives of the solutions of the embodiments. In addition, in the accompanying drawings of the apparatus embodiments provided in the disclosure, connection relationships between modules indicate that the modules have communication connections with each other, which may be implemented as one or more communications buses or signal cables. A person of ordinary skill in the art may understand and implement the embodiments of the disclosure without creative efforts.

Based on the description of the foregoing implementation manners, a person skilled in the art may clearly understand that the disclosure may be implemented by software in addition to necessary universal hardware, or by dedicated hardware, including an application-specific integrated circuit (ASIC), a dedicated CPU, a dedicated memory, a dedicated component, and the like. Usually, any functions that can be performed by a computer program can be easily implemented by using corresponding hardware. Moreover, a specific hardware structure used to achieve a same function may be of various forms, for example, in a form of an analog circuit, a digital circuit, a dedicated circuit, or the like. However, as for the disclosure, software program implementation is a better implementation manner in most cases. Based on such an understanding, the technical solutions of the disclosure essentially or the part contributing to the prior art may be implemented in a form of a software product. The computer software product is stored in a readable storage medium, such as a floppy disk, a universal serial bus (USB) flash drive, a removable hard disk, a read-only memory (ROM), a random access memory (RAM), a magnetic disk, or an optical disc of a computer, and includes several instructions for instructing a computer device (which may be a personal computer, a server, a network device, and the like) to perform the methods described in the embodiments of the disclosure.

The payment method, the payer terminal, and the payee terminal that are provided in the embodiments of the disclosure are described above in detail. A person of ordinary skill in the art may, based on the idea of the embodiments of the disclosure, make modifications with respect to the specific implementation manners and the application scope. Therefore, the content of this specification shall not be construed as a limitation to the disclosure.

What is claimed is:

1-39. (canceled)

40. A payment method for a payer terminal comprising:
receiving a transaction request from a payee terminal installed with electronic cash applications, wherein the transaction request comprises a payment amount;
determining whether there is at least one electronic cash application from the electronic cash applications whose balance independently covers the payment amount;
determining whether there are at least two electronic cash applications from the electronic cash applications whose sum of balances is greater than or equal to the payment amount when none of the electronic cash applications has a balance to independently cover the payment amount;
selecting a group of electronic cash applications from the electronic cash applications whose sum of balances is greater than or equal to the payment amount;
allocating a corresponding payment sub-amount of the payment amount to each electronic cash application from the selected group of electronic cash applications;
deducting the corresponding payment sub-amount from a balance amount of each of the selected group of electronic cash applications until a sum of the deduction is equal to the payment amount when there are at least two electronic cash applications, wherein at least two of the electronic cash applications have balances whose sum of is greater than or equal to the payment amount; and
sending an account number and corresponding deduction data of each of the selected group of electronic cash applications and a transaction identification related to the transaction request to the payee terminal or to a server.

41. The method according to claim 40, wherein selecting the group of electronic cash applications comprises selecting the group of electronic cash applications from the electronic cash applications according to one or more of priorities of the electronic cash applications, a maximum usage quantity of electronic cash applications in one transaction, or a user indication.

42. The method according to claim 40, further comprising returning a transaction response to the payee terminal, wherein the transaction response indicates that the payer terminal can pay the payment amount.

43. The method according to claim 42, further comprising receiving, from the payee terminal, a confirmation request requesting the payer terminal to use the selected group of electronic cash applications to complete a current transaction.

44. The method according to claim 40, further comprising selecting one electronic cash application from the electronic cash applications whose balance independently covers the payment amount for completing a current payment when there is at least one electronic cash application whose balance independently covers the payment amount.

45. The method according to claim 44, wherein selecting the one electronic cash application comprises selecting, the one electronic cash application from the electronic cash applications whose balance independently covers the payment amount according to one or more of priorities of the electronic cash applications, a maximum usage quantity of electronic cash applications in one transaction, or a user indication.

46. The method according to claim 40, wherein the transaction identification related to the transaction request comprises a transaction sequence number related to the transaction request.

47. A payment method applied to a payee terminal, wherein the method comprises:
sending, by the payee terminal, a transaction request to a payer terminal, wherein the transaction request comprises a payment amount;
receiving, from the payer terminal, information comprising each of an account number and a corresponding deduction data of each selected electronic cash applications from a plurality of cash applications and a transaction identification associated with the transaction request;
encapsulating, by the payee terminal in a settlement packet, the received information; and
sending, by the payee terminal, the settlement packet to a server, wherein the settlement packet includes instructions to centrally perform synchronous fee deduction on accounts corresponding to each of the selected electronic cash applications associated with a current transaction sequence number.

48. The method according to claim 47, further comprising:
receiving a transaction response from the payer terminal, wherein the transaction response indicates that a corresponding payment sub-amount is to be deducted from a balance amount of each of the selected electronic cash applications; and
sending a confirmation request to the payer terminal for requesting use of each of the selected electronic cash applications to complete a current transaction corresponding to the transaction request.

49. The method according to claim 47, further comprising receiving a settlement response from the server, wherein the settlement response is indicative of the centrally performed synchronous fee deduction on the accounts corresponding to each of the electronic cash applications associated with the current transaction sequence number.

50. A payer terminal, comprising:
a transceiver; and
a processor coupled to the transceiver, wherein the processor is configured to:
receive a transaction request from a payee terminal having electronic cash applications, wherein the transaction request comprises a payment amount;
determine whether there is at least one electronic cash application from the electronic cash applications whose balance independently covers the payment amount;
determine whether there are at least two electronic cash applications from the electronic cash applications whose sum of balances is greater than or equal to the payment amount when none of the electronic cash applications has a balance to independently cover the payment amount;
select a group of electronic cash applications from the electronic cash applications whose sum of balances is greater than or equal to the payment amount;
allocate a corresponding payment sub-amount of the payment amount to each electronic cash application from the selected group of electronic cash applications; and
deduct the corresponding payment sub-amount from a balance amount of each of the selected group of electronic cash applications until a sum of a deduction is equal to the payment amount when there are at least two electronic cash applications, wherein at least two of the electronic cash applications have balances whose sum is greater than or equal to the payment amount, and wherein the transceiver is configured to send an account number and corresponding deduction data of each of the selected group of electronic cash applications and a transaction identification related to the transaction request to the payee terminal or to a server.

51. The payer terminal according to claim 50, wherein the processor is further configured to select the group of electronic cash applications according to one or more of priorities of the electronic cash applications, a maximum usage quantity of electronic cash applications in one transaction, or a user indication.

52. The payer terminal according to claim 50, wherein the transceiver is further configured to return a transaction response to the payee terminal, wherein the transaction response indicates that the payer terminal can pay the payment amount.

53. The payer terminal according to claim 52, wherein the transceiver is further configured to receive, from the payee terminal, a confirmation request requesting the payer terminal to use the selected group of electronic cash applications to complete a current transaction.

54. The payer terminal according to 50, wherein the processor is further configured to select one electronic cash application from the electronic cash applications whose balance independently covers the payment amount for completing a current payment when there is at least one electronic cash application whose balance independently covers the payment amount.

55. The payer terminal according to 54, wherein the processor is further configured to select the one electronic cash application from the electronic cash applications whose balance independently covers the payment amount according to one or more of priorities of the electronic cash applications, a maximum usage quantity of electronic cash applications in one transaction, or a user indication.

56. The payer terminal according to 50, wherein the transaction identification related to the transaction request comprises a transaction sequence number related to the transaction request.

57. The method according to claim 42, further comprising returning a transaction response to the payee terminal, wherein the transaction response indicates that the corresponding payment sub-amount is to be deducted from the balance amount of each of the selected group of electronic cash applications.

58. The payer terminal according to claim 52, wherein the processor is further configured to return a transaction response to the payee terminal, wherein the transaction response indicates that the corresponding payment sub-amount will be deducted from the balance amount of each selected group of electronic cash applications.
